(19) United States
(12) Patent Application Publication
(10) Pub. No.: US 2008/0198117 A1
(43) Pub. Date: Aug. 21, 2008

(54) Display Device, Liquid Crystal Monitor, Liquid Crystal Television Receiver, and Display Method

(76) Inventor: Takeshi Kumakura, Nara (JP)

Correspondence Address: HARNESS, DICKEY & PIERCE, P.L.C., P.O. BOX 8910, RESTON, VA, 20195, US

(21) Appl. No.: 11/885,281

(22) PCT Filed: Mar. 7, 2006
(86) PCT No.: PCT/JP06/04405

§ 371 Date: Aug. 29, 2007

(30) Foreign Application Priority Data
Mar. 11, 2005 (JP) 2005-069749

(51) Int. Cl. G09G 3/36

(52) U.S. Cl. 345/89

(57) ABSTRACT

In the present display device, a control section (15) divides each frame into a preceding subframe and a succeeding subframe and designates the preceding subframe for black display for low luminance and the succeeding subframe for white display for high luminance. That mitigates excess brightness phenomena. The control section (15) adjusts emission of a light source in the display section (14) by PWM light adjustment, setting the light adjustment frequency to n.5 times the frame frequency and not lower than 450 Hz. That prevents horizontal stripes from occurring. The light adjustment frequency is so raised that flickering is less recognizable.

### TECHNICAL FIELD

The present invention relates to display devices which display images by dividing each frame into a plurality of subframes.

### BACKGROUND ART

An increasing number of liquid crystal displays, especially, color liquid crystal displays with a TN (Twisted Nematic) liquid crystal display panel (TN-mode liquid crystal panel, TN panel) are being used in recent years in what has been traditionally the fields for CRTs (cathode ray tubes). For example, Patent Document 1 discloses a liquid crystal display switching between TN panel driving methods according to whether the display image is a moving image or a still image.

These TN panels have some problems associated with viewing angle characteristics when compared to CRTs. Grayscale characteristics change with an increasing line-of-sight angle (angle at which the panel is viewed; angle between the normal to the panel and the direction in which the panel is viewed). At some angles, grayscale inversion occurs.

Techniques have been accordingly developed which improve viewing angle characteristics by using an optical film and also which mitigate grayscale inversion by modifying a display method. For example, Patent Documents 2 and 3 disclose a method whereby each frame is divided to write a signal to one pixel more than once and another in which signal write voltage levels are combined for improvement.

The viewing angle of TVs (television receivers) and other liquid crystal display panels which require wide viewing angles is increased by using liquid crystal of IPS (In-plane switching) mode, VA (Vertical Alignment) mode, or like mode, instead of TN mode. For example, A VA-mode liquid crystal panel (VA panel) shows a contrast of 10 or greater within 170° up/down/left/right and is free from grayscale inversion.
Patent Document 1: Japanese Unexamined Patent Publication (Tokukai) 2001-296841 (published Oct. 26, 2001)
Patent Document 2: Japanese Unexamined Patent Publication 5-68221/1993 (Tokukaihei 5-68221; published Mar. 19, 1993)
Patent Document 3: Japanese Unexamined Patent Publication (Tokukai) 2002-23707 (published Jan. 25, 2002)
Patent Document 4: Japanese Unexamined Patent Publication (Tokukai) 2000-321551 (published Nov. 24, 2000)
Patent Document 5: Japanese Unexamined Patent Publication 9-127917/1997 (Tokukaihei 9-127917; published May 16, 1997)
Patent Document 6: Japanese Unexamined Patent Publication (Tokukai) 2004-4659 (published Jan. 8, 2004)
Non-patent Document 1: New Handbook for Color Science, Ed. 2 (Tokyo University Press; published Jun. 10, 1998)

### DISCLOSURE OF INVENTION

However, even VA panels, reputed to have a wide viewing angle, cannot completely prevent grayscale characteristics from changing with the viewing angle. Their grayscale characteristics deteriorate, for example, at large viewing angles in left and right directions.

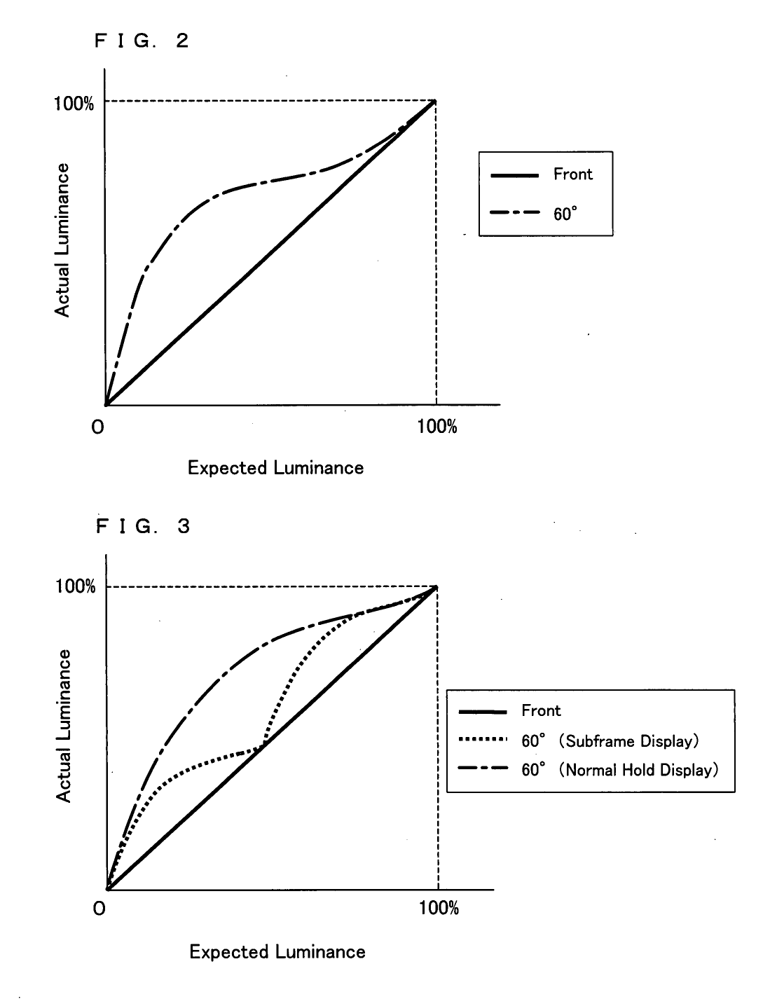

Specifically, as shown in FIG. 2, grayscale γ-characteristics at 60° viewing angle differ from those when the panel is viewed from the front (that is, viewing angle=0°). That leads to an excess brightness phenomenon in which halftone luminance becomes excessively bright.

The IPS mode liquid crystal panel has similar problems. Grayscale characteristics change with an increasing viewing angle, albeit on a different scale, depending on the design of optical films and other optical properties.

The present invention, conceived to address these conventional problems, has an objective of providing a display device capable of mitigating the excess brightness phenomenon.

The display device of the present invention is, to address the problems, designed as follows. The display device displays an image by dividing each frame into m subframes (m is an integer greater than or equal to 2), the display device including: a display section displaying an image with luminance in accordance with a display signal voltage; and a control section generating first to m-th display signals for the first to m-th subframes for output to the display section so that the dividing of the frames does not change a sum luminance output of the display section in each frame, wherein the control section adjusts emission of a light source in the display section by PWM light adjustment.

The present display device displays an image using a display section including a display screen, provided by a liquid crystal display element. The present display device is adapted so that the control section drives the display section by subframe display. Subframe display is a display scheme whereby each frame is divided into plural (m; m is an integer more than or equal to 2) subframes (first to m-th subframes).

In other words, the control section outputs a display signal to the display section m times per frame period (sequentially outputs the first to m-th display signals for the first to m-th subframes). Accordingly, the control section turns on all the gate lines of the display screen in the display section once per subframe period (m times per frame).

The control section preferably sets the output frequency (clock) of the display signal to m times that for ordinary hold display (m double clock). Ordinary hold display is an ordinary display scheme whereby no frame is divided into subframes (all the gate lines of the display screen are turned on only once per frame period).

The display section (display screen) is designed to display an image with luminance in accordance with a display signal voltage (voltage in accordance with a luminance grayscale level represented by a display signal) supplied from the control section.

The control section is adapted to generate the first to m-th display signals (specify the display signal voltages) so as to maintain the same sum luminance (total luminance) output of the screen in each frame by dividing the frame. The display signal voltage is a voltage applied to the liquid crystal in each pixel in the display section (liquid crystal driving voltage).

Generally, with the display screen in the display section, the discrepancy between the actual brightness and the expected brightness (brightness discrepancy) at large viewing angles can be sufficiently reduced as the display signal voltage (liquid crystal driving voltage) approaches a minimum or a maximum.

Brightness is a degree of brightness sensed by a human in accordance with the luminance of the image being displayed. See equations/inequalities (5), (6) in the embodiment (detailed later). If the sum luminance output over one frame is constant, the sum brightness output over one frame is also constant.

The expected brightness is the expected brightness output of the display screen (value in accordance with the liquid crystal driving voltage). The actual brightness is the actual brightness output of the screen and variable with viewing angle. Viewing the screen from the front, the actual brightness is equal to the expected brightness, producing no brightness discrepancy. On the other hand, as the viewing angle increases, the brightness discrepancy also grows.

Therefore, in the present display device, to display an image, the control section preferably changes the voltage of at least one of the first to m-th display signals so that the voltage approaches a minimum or a maximum. The control sufficiently reduces brightness discrepancy in at least one subframe. Accordingly, the present display device reduces brightness discrepancy and improves viewing angle characteristics over ordinary hold display, which in turn well mitigates excess brightness phenomena.

The same subframe display is capable of also improving the display quality of moving images. More specifically, if one follows the motion of an object being displayed by ordinary hold display with his/her eyes, he/she would perceive at the same time the color and brightness of the immediately preceding frame. That results in the viewer perceiving blurred object edges.

In contrast, when producing a moving image by subframe display (especially, at low luminance), the luminance in one of the subframes in each frame is low. The low luminance subframe restrains visual mixing of the currently perceiving frame image and the immediately preceding frame image (color, brightness). The edge blurring is thereby prevented, improving the display quality of moving images.

The present display device is designed to adjust light by PWM light adjustment. The display section (liquid crystal display element) in the present display device produces grayscale displays by controlling the amount of transmitted light. To do so, some light source (fluorescent tube, LED, EL, FED, etc.) is needed. Current, large display elements typically use a fluorescent tube for its high efficiency as a light source.

There are two popular light adjustment schemes for a light source: current-based light adjustment, or voltage light adjustment, and PWM light adjustment.

Current-based light adjustment varies the amplitude of current (lamp current) supplied to a light source to control the output light intensity (brightness) of the light source. If a fluorescent tube is used as the fight source, the fluorescent tube does not light on with too small lamp current amplitudes. Thus, current-based light adjustment has a shortcoming that it cannot provide a wide light adjustment range (range of available brightness). Therefore, PWM light adjustment is a preferred choice in devices which require a wide light adjustment range such as liquid crystal televisions.

Simply combining PWM light adjustment and subframe display possibly causes interference, such as flickers and horizontal stripes. In other words, in subframe display with PWM light adjustment, the light adjustment frequency interferes with the subframe frequency. The frequency of the waveform of the light transmitted by the display section (transmission waveform) may fall far below the light adjustment frequency. In cases like this, the user sees intense flickers.

Such flickers intensify as the light adjustment frequency approaches n.5 times the frame frequency (n is an integer). If the light adjustment frequency is n times the frame frequency, the transmission waveform frequency equals the frame frequency. Therefore, the flickers can be reduced so they are less recognizable. However, as the light adjustment frequency approaches n times the frame frequency, the interference (horizontal stripes) occurs on the screen.

In other words, the light source usually projects light simultaneously to each part of the screen. In contrast, the display section (liquid crystal display element) shines a line at a time. Therefore, the individual lines of the display screen turn on/off at different times depending on where they are located. Therefore, the liquid crystal response waveform goes ON/OFF at different timings on lines that are located at different places (slides with respect to time).

Therefore, the ratio of the ON duration of the transmission waveform (duration of high luminance) differs from one line position to the next. Therefore, average luminance differs from one line to the other, which is recognized as horizontal stripes.

If the light adjustment frequency is exactly n times the frame frequency, the horizontal stripes sit still on the screen. As the light adjustment frequency deviates from n times, the horizontal stripes start to float up and down on the screen. As the light adjustment frequency further deviates from n times and approaches n.5 times, the horizontal stripes disappear.

In other words, if the light adjustment frequency is n.5 times the frame frequency, the light source emission waveform changes its phase by 180° between adjoining frames. Therefore, the transmission waveform from each line also changes its phase by 180° between adjoining frames. Thus, the amount of transmitted light from each line is invariable if summed over two adjoining frames (time compensated). That prevents horizontal stripes from occurring.

Accordingly, the present display device is preferably adapted so that when PWM light adjustment and subframe display are used together, the control section sets the light adjustment frequency to n.5 times the frame frequency, not lower than 450 Hz.

When that is the case, the horizontal stripes do not occur because the light adjustment frequency is set to n.5 times the frame frequency. In addition, although the frequency of the transmission waveform for each line is half the frame frequency, the flickers become less recognizable because the light adjustment frequency is raised sufficiently.

In other words, some pairs of lines in the display section (lines “A and B”) have a “transposed” relationship for each frame. The amount of light for line A in frame 1 (or frame 2) is equal to the amount of light for line B in frame 2 (or frame 1). If pairs of lines which are related this way are provided densely on the screen, the flickers are space compensated by the user viewing light from the pairs of lines simultaneously.

The on-screen distance separating the pair of lines related this way decreases with increasing light adjustment frequency. Therefore, the flickers become less recognizable by raising the light adjustment frequency sufficiently even if its value is set to n.5 times the frame frequency.

Our experiments demonstrate that flickers are less recognizable if the light adjustment frequency is 450 Hz or higher when the luminance is set to 50% (black insertion ratio=50%). Flickers are most recognizable when the black insertion ratio is 50%.

Therefore, the present display device is adapted to set the light adjustment frequency to n.5 times the frame frequency, not lower than 450 Hz, to prevent both the horizontal stripes and the flickers from occurring.

The interference can be mitigated without raising the light adjustment frequency as above. This is realized by, for example, producing the light source emission waveform from a combination of base light pulses and luminance correction pulses both of which have a frequency n.5 times the frame frequency and different pulse widths and which are in opposite phase.

In the structure, the transmission waveforms for individual lines show that the transmission amount of the base light pulses and the luminance correction pulses fluctuates from frame to frame and that the ratio inverts from frame to frame. For example, when the ratio of the base light pulses (HIGH) in frame 1 and those in frame 2 for one line is 2.5:3, the ratio of the luminance correction pulses in frame 1 and those in frame 2 is 3:2.5 (inverse).

Hence, the transmission waveform, although its frequency is low, possesses a reduced luminance difference between frames owing to the use of the luminance correction pulses. Therefore, the flickers become less recognizable.

The structure reduces the light adjustment frequency to below 450 Hz and thereby prevents light source driving efficiency from decreasing. The structure employs two pulses, which may raise concerns about poor efficiency. However, the luminance correction pulses has a pulse width which is much shorter than the frame period. Therefore, the luminance correction pulses affect the light source driving efficiency in a sufficiently limited manner.

The light adjustment frequency may be set to n times the frame frequency. For example, the control section controls the light source to emit base light pulses with a relatively long pulse width at a frequency n times the frame frequency. The control section also controls the light source so that the base light pulses are inverted in phase from one frame to the next.

The control prevents the horizontal stripes from occurring. Preferably, a measure should be taken to reduce the flickers. Accordingly, the control section inserts the luminance correction pulses with a relatively short pulse width in the light source emission waveform at the same frequency as the base light pulses, but in opposite phase. Furthermore, the control section inserts, in place of the luminance correction pulses, luminance correction additive pulses or luminance correction subtractive pulses when the base light pulses change in phase.

The luminance correction additive pulse is inserted when the base light pulses continue to be off (low) and turns on the light source. In contrast, the luminance correction subtractive pulse is inserted when the base light pulses continue to be on (high) and turns off the light source.

In other words, the structure is designed to increase the amount of light by inserting a luminance correction additive pulse when the amount of light of the base light pulses is too small and to decrease the amount of light by inserting a luminance correction subtractive pulse when the amount of light of the base light pulses is too large.

Accordingly, the structure reduces luminance difference between frames for each line (brings average luminance over each frame to a constant value). That reduces flickering.

When a combination of subframe display and PWM light adjustment is used in the present display device, if the display section has a plurality of light sources, the control section preferably carries out PWM light adjustment so that at least two of the light source emission waveforms have different phases.

The structure causes a discrepancy in the light source emission waveforms, thus increases the DC component in the mixed light of all the light sources. That reduces variations over time in the emission by the light source and also lowers difference in emission from line to line, which in turn makes the interference, such as flickers and horizontal stripes, less recognizable without a need to increase the frequency of the light adjustment signal.

In a case like this, the control section preferably divides the light sources into p groups (p is a natural number greater than 1) and controls each group of light sources so that the light source emission waveforms are 360°/p out of phase from one group to the other. The division and control increases the DC component in the mixed light.

If a plurality of light sources are used as above, the light sources may be direct backlights, side backlights, side frontlights, etc. If backlights are used, the display section may be either a transmissive or transflective display element. For frontlights, the display section may be a reflective display element.

If the display section has a group of direct light sources positioned side by side, each light source illuminates a group of gate lines (some of all the gate lines) positioned close to that light source.

In a case like this, the control section preferably sets the frequency of the light source emission waveform to n times the frame frequency and carries out PWM light adjustment so that any one of the light sources (for any one of the groups of gate lines) exhibits the same emission waveform when one of the groups of gate lines assigned to that light source goes ON.

In a case like this, since the light adjustment frequency is n times the frame frequency, there occurs no flickering. In the structure, the phases of the light source emission waveforms correspond to those of the liquid crystal response waveforms for all the groups of gate lines. Therefore, the structure prevents the ratio of the ON duration of the transmission waveform (duration of high luminance) from differing from one line position to the next. Therefore, average luminance does not differ from one line to the other. That prevents horizontal stripes from occurring.

When a combination of subframe display and PWM light adjustment is used in the present display device, the control section may be set up to carry out PWM light adjustment while supplying a constant emission power to the light sources.

Accordingly, the emission waveform is a sum of a constant amplitude and an amplitude in accordance with the PWM light adjustment. The DC component in the emission waveform is readily increased.

That reduces variations over time in the emission by the light sources and also lowers difference in emission from line to line, which in turn makes the interference, such as flickers and horizontal stripes, less recognizable without a need to increase the frequency of the light adjustment signal.

The emission of the light sources may be controlled according to external light if a combination of subframe display and PWM light adjustment is employed and the display section is a reflective or transflective liquid crystal display element.

In the structure, the display section preferably includes a luminance sensor detecting the luminance waveform of the external light shining onto the display section. The display section is preferably such that the control section carries out PWM light adjustment so that the light source exhibits an emission waveform which is of the same frequency as, and in opposite phase with respect to, the luminance waveform of the external light.

In the structure, the display section is illuminated with light with a large DC component produced by mixing light of the same frequency and in opposite phase. The structure reduces variations over time in the emission by the light source and also lowers difference in emission from line to line, which makes the interference, such as flickers and horizontal stripes, less recognizable without a need to increase the frequency of the light adjustment signal. The light source in the present display device may be a fluorescent tube, an LED, an EL device, an FED, etc.

A combination of the present display device and the image signal feeder section (signal feeder section) provides a liquid crystal monitor used in, for example, a personal computer.

The image signal feeder section is for transferring externally supplied image signals to the control section. In the structure, the control section in the present display device generates the display signals from the image signals supplied from the image signal feeder section and outputs the display signals to the display section.

A combination of the present display device and the tuner section provides a liquid crystal television receiver.

The tuner section is for the reception of television broadcast signals. In the structure, the control section in the present display device generates the display signals from the television broadcast signals supplied from the tuner section and outputs the display signals to the display section.

The image display method of the present invention (present display method) displays an image by dividing each frame into m subframes (m is an integer greater than or equal to 2), the display method involving the steps of: (a) generating first to m-th display signals for the first to m-th subframes for output to a display section provided by a liquid crystal display element so that the dividing of the frames does not change a sum luminance output of the display section in each frame; and (b) adjusting emission of a light source in the display section by PWM light adjustment.

The present display method is used with the present display device. Therefore, the display method causes small brightness discrepancy when compared to ordinary hold display, thereby improving viewing angle characteristics. That well mitigates excess brightness phenomena and improves the display quality of a moving image.

Furthermore, the light adjustment by PWM light adjustment allows a wider range of light adjustment than current-based light adjustment.

As described in the foregoing, the display device of the present invention is designed as follows. The display device displays an image by dividing each frame into m subframes (m is an integer greater than or equal to 2), the display device including: a display section displaying an image with luminance in accordance with a display signal voltage; and a control section generating first to m-th display signals for the first to m-th subframes for output to the display section so that the dividing of the frames does not change a sum luminance output of the display section in each frame, wherein the control section adjusts emission of a light source in the display section by PWM light adjustment.

The present display device carries out subframe display to reduce brightness discrepancy when compared to ordinary hold display. That improves viewing angle characteristics and well mitigates excess brightness phenomena. The display quality of a moving image also improves Furthermore, the light adjustment by PWM light adjustment allows a wider range of light adjustment than current-based light adjustment.

Additional objects, advantages and novel features of the invention will be set forth in part in the description which follows, and in part will become apparent to those skilled in the art upon examination of the following or may be learned by practice of the invention.

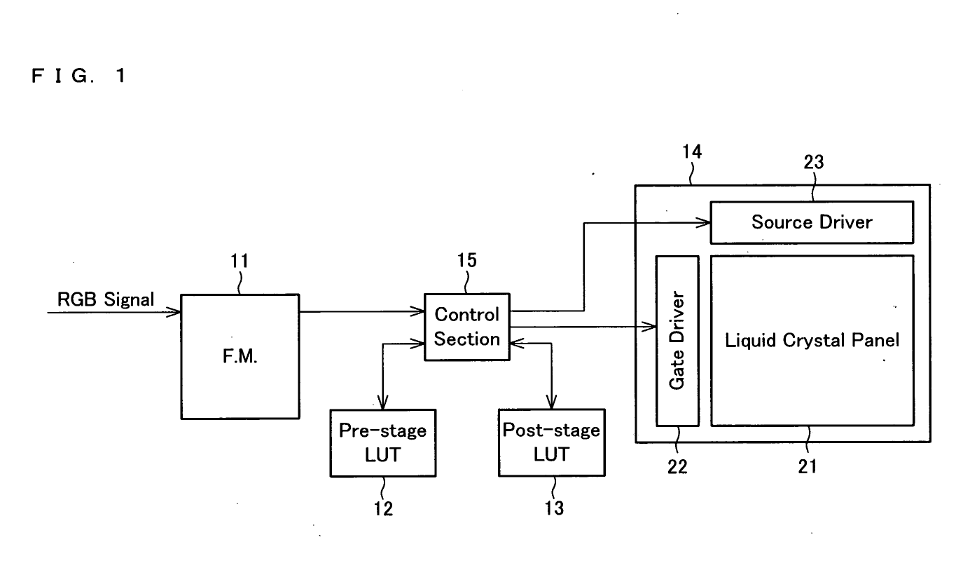

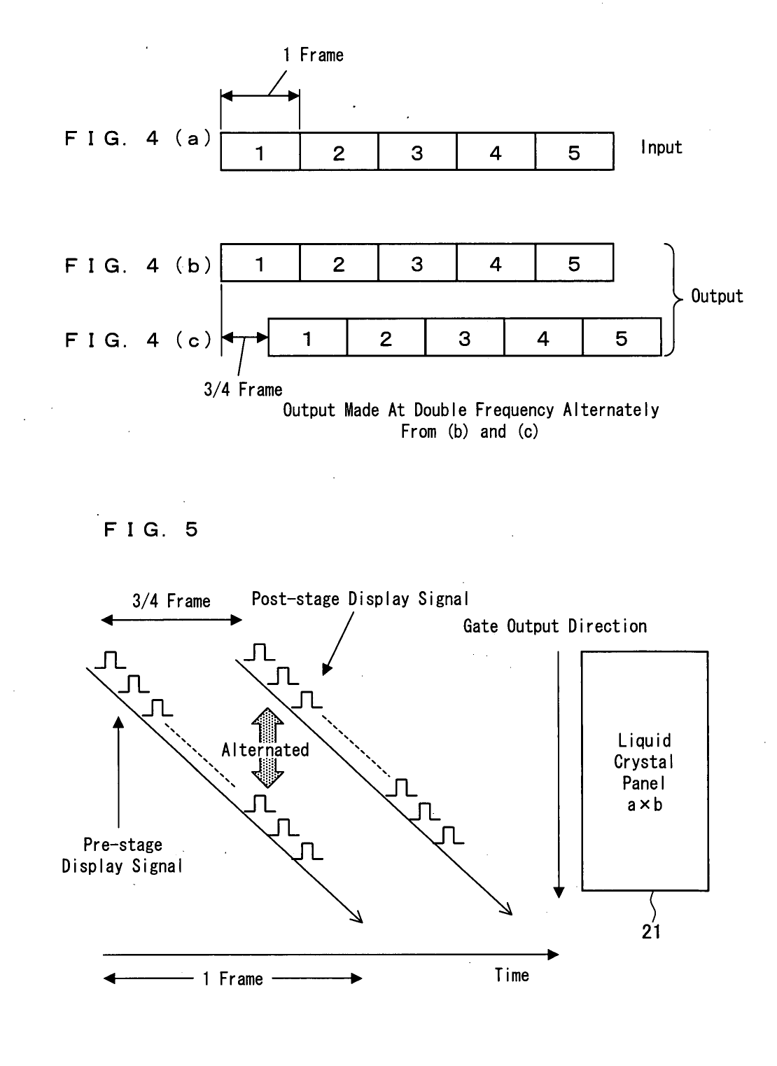

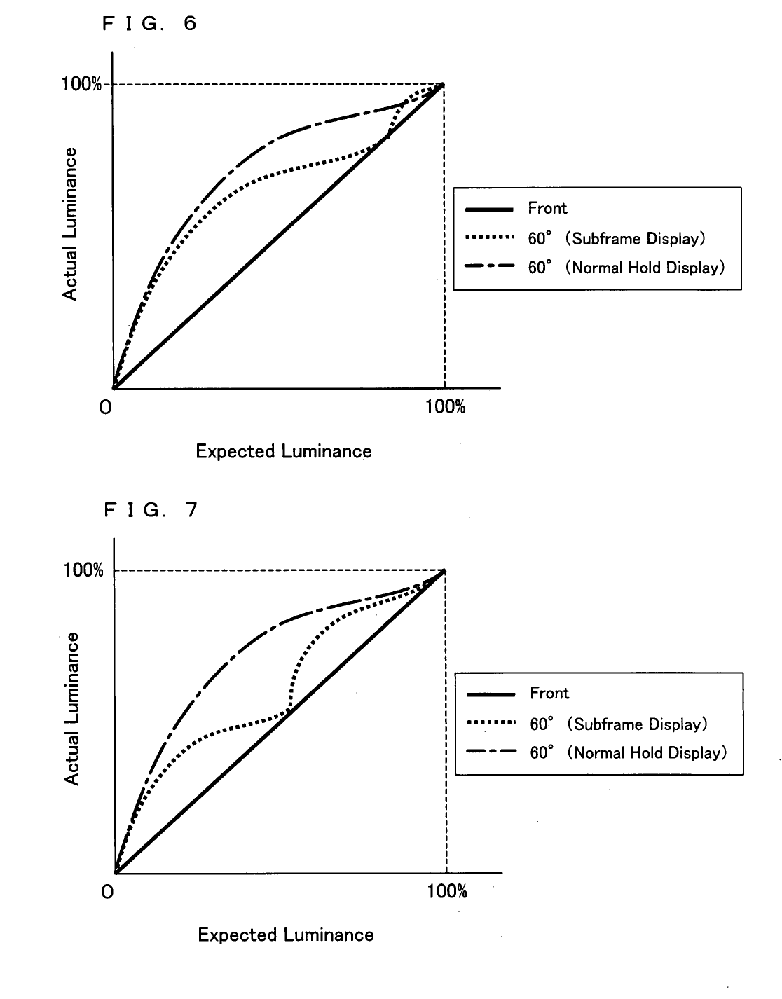

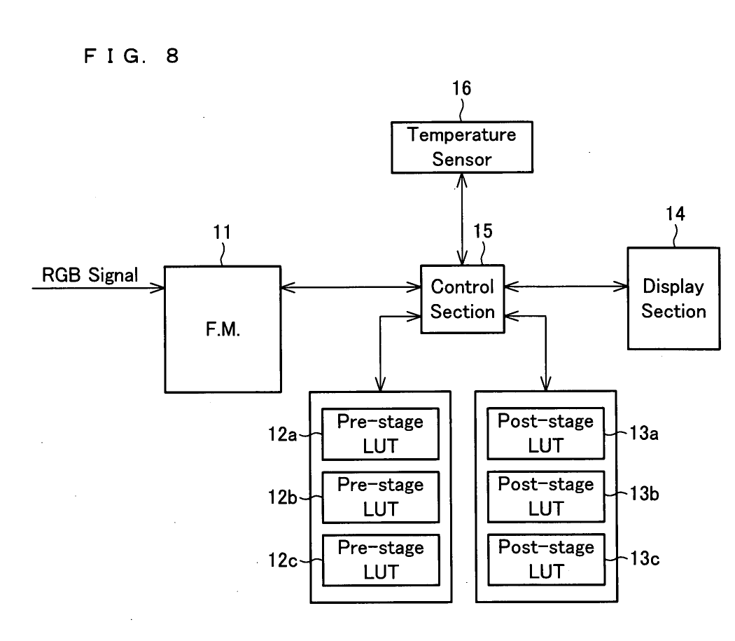

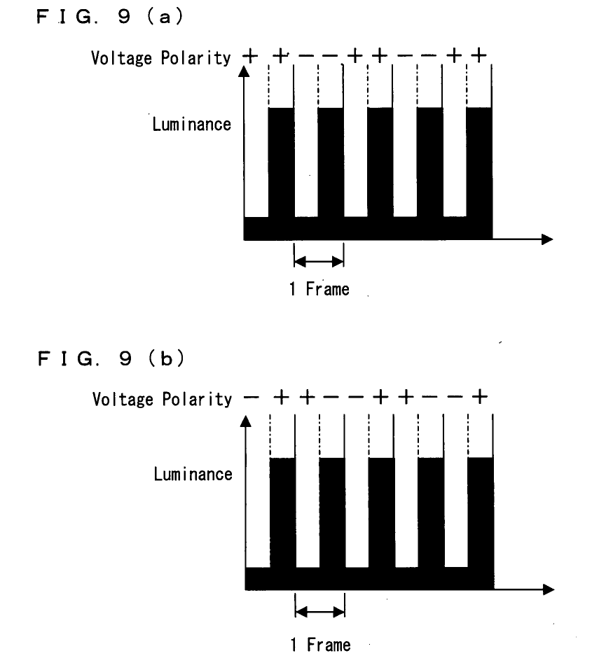

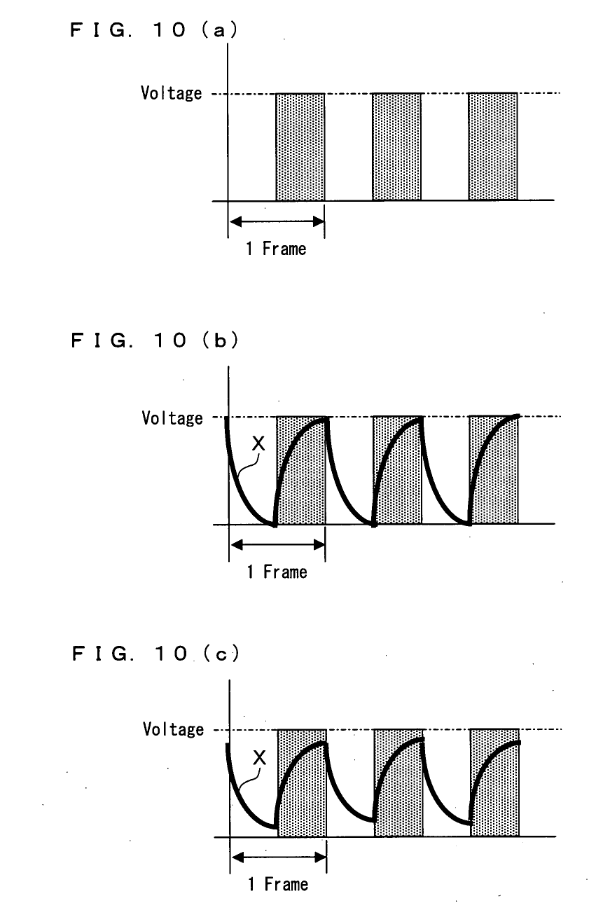

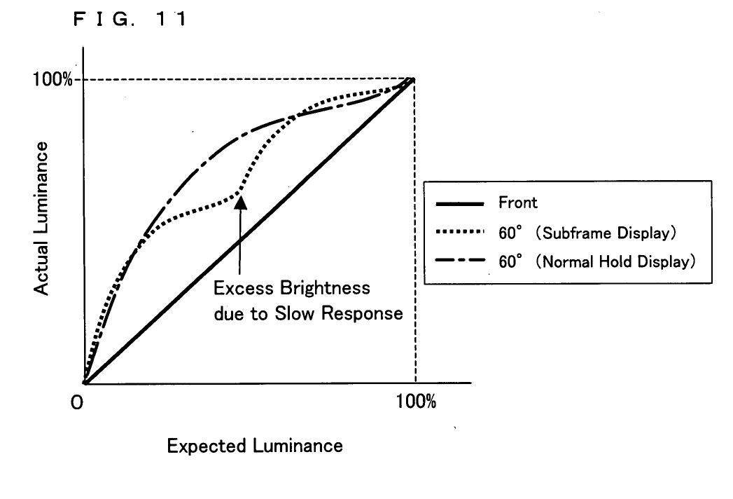

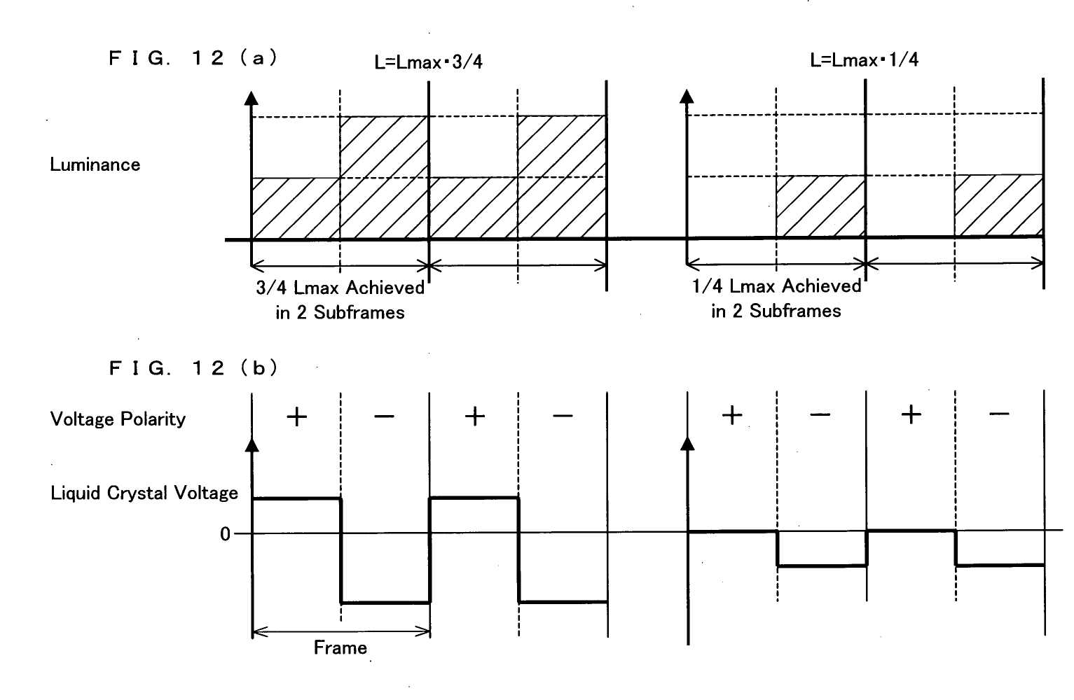

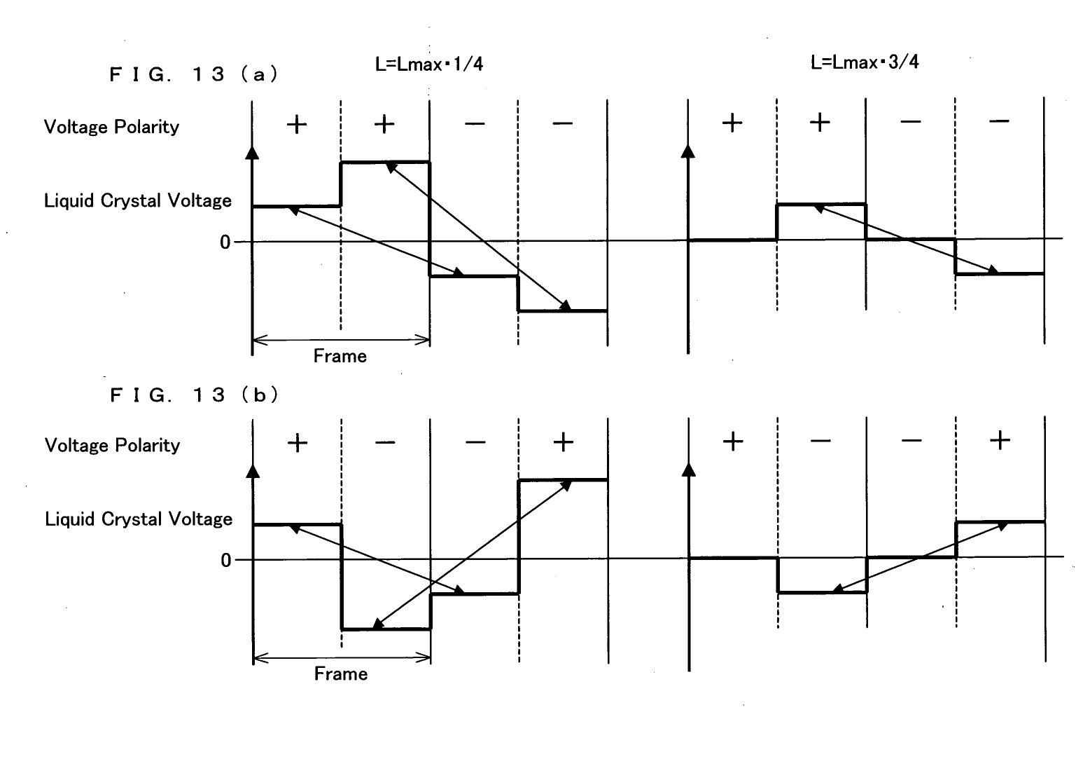

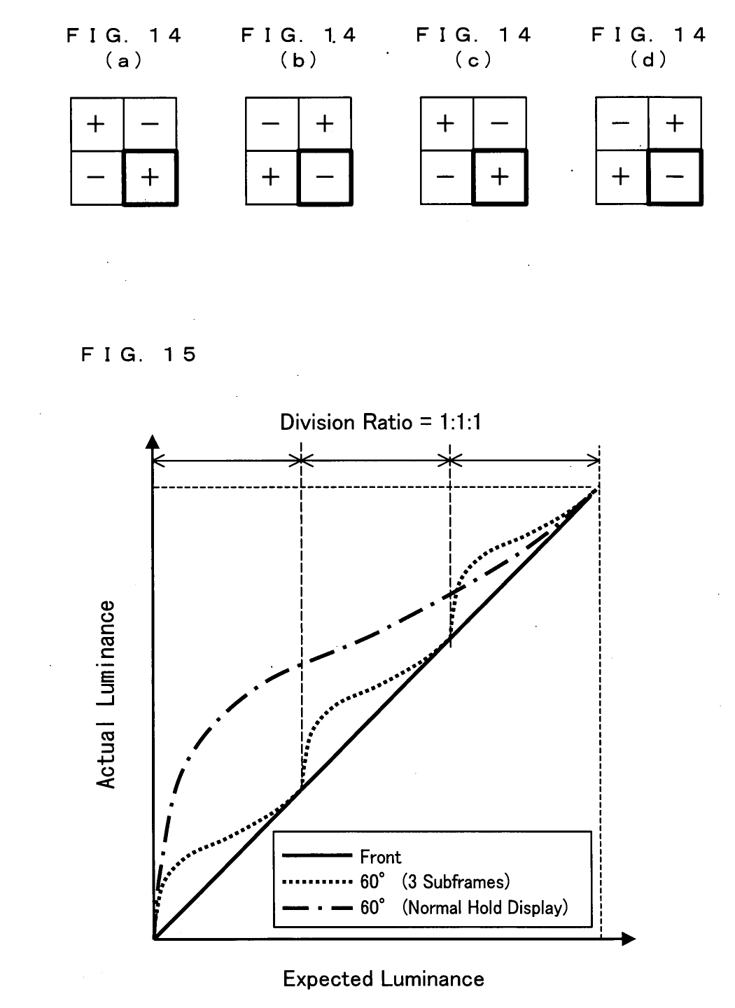

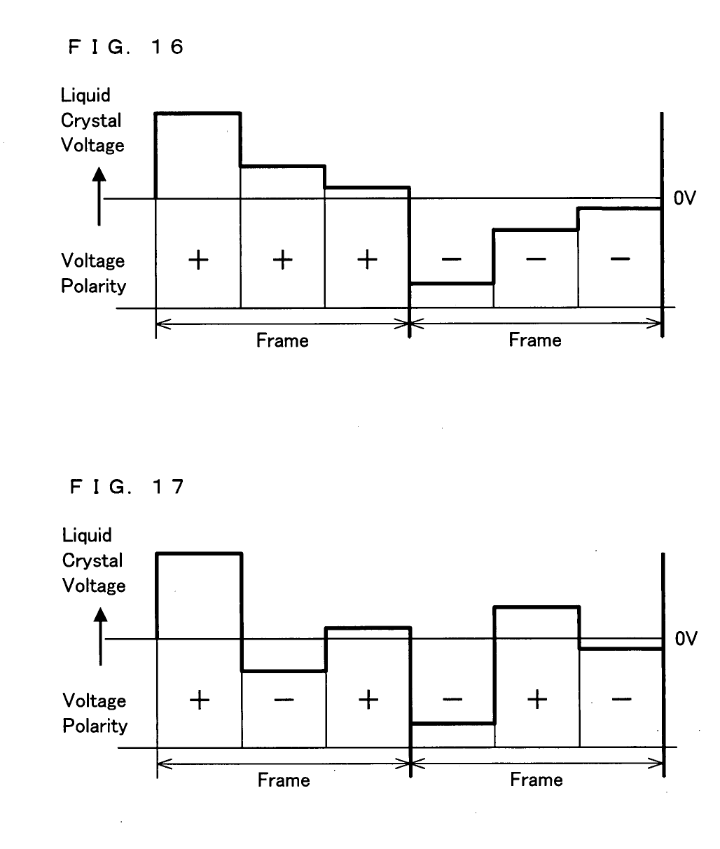

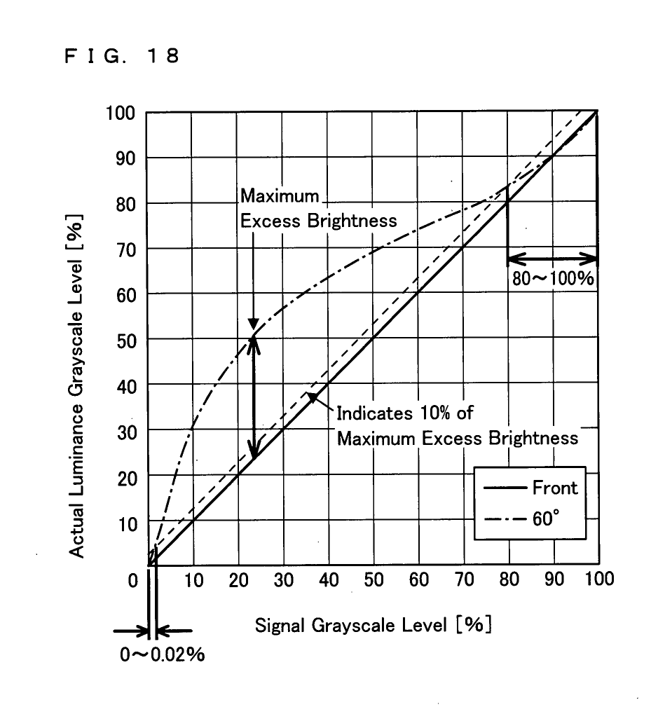

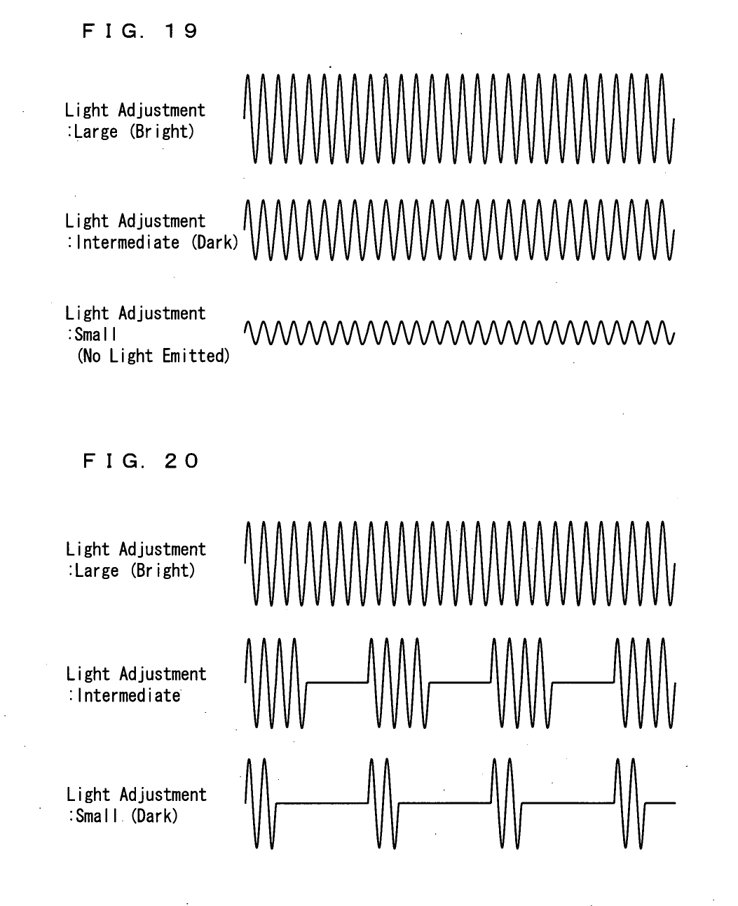

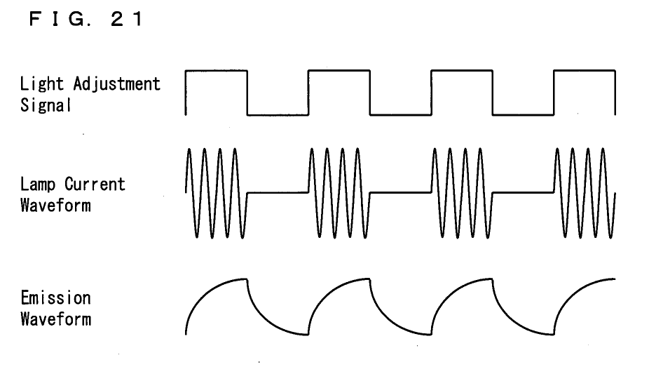

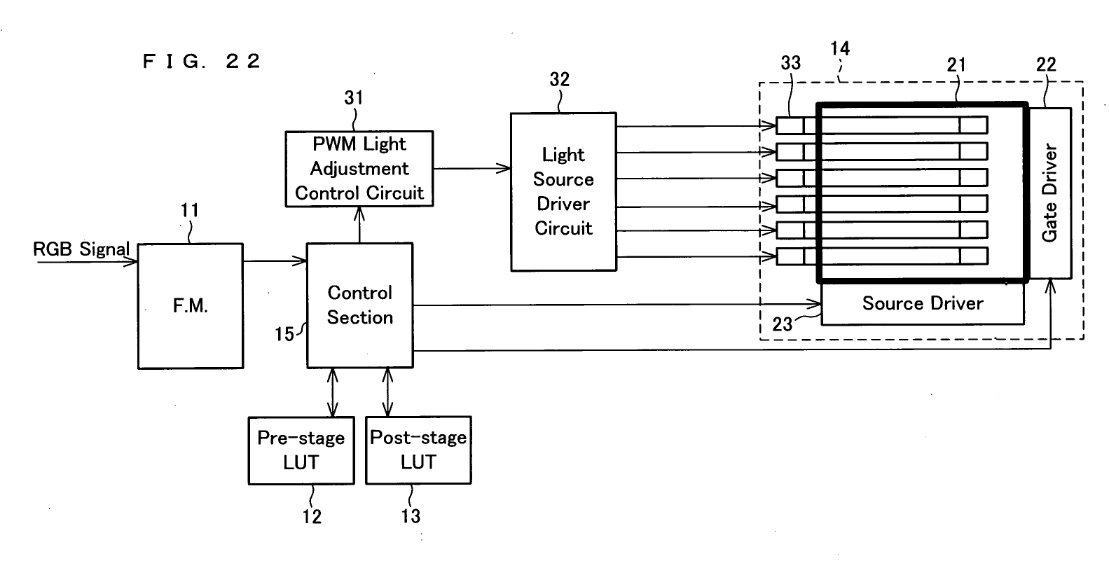

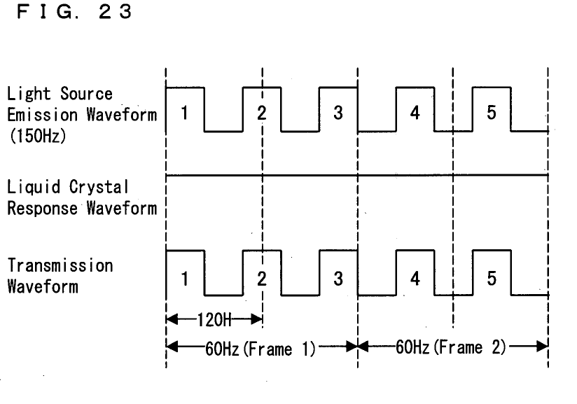

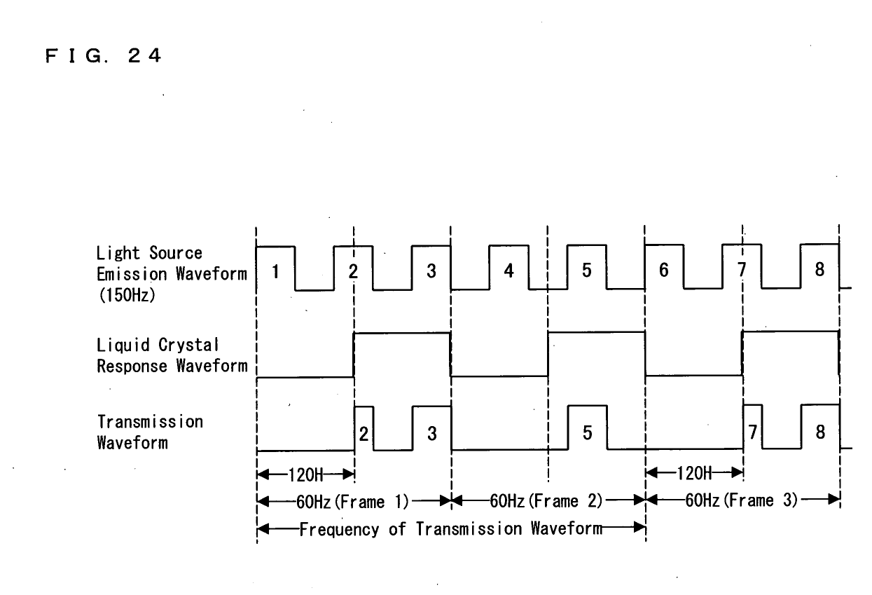

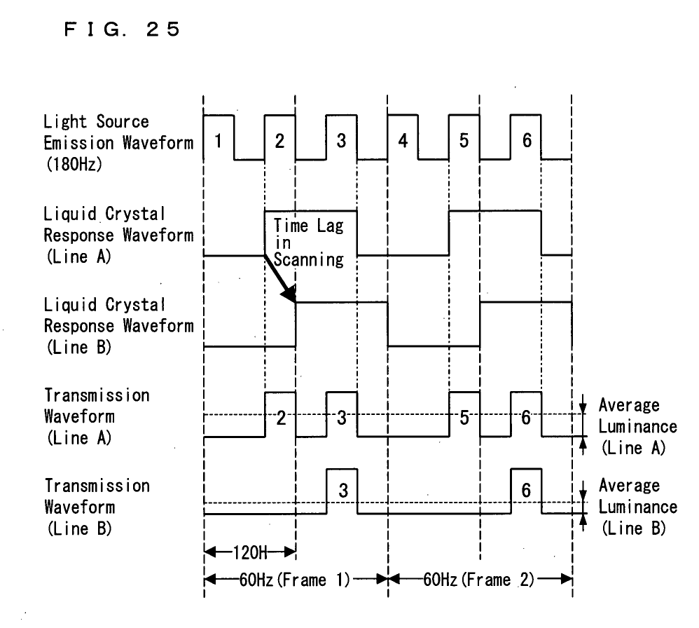

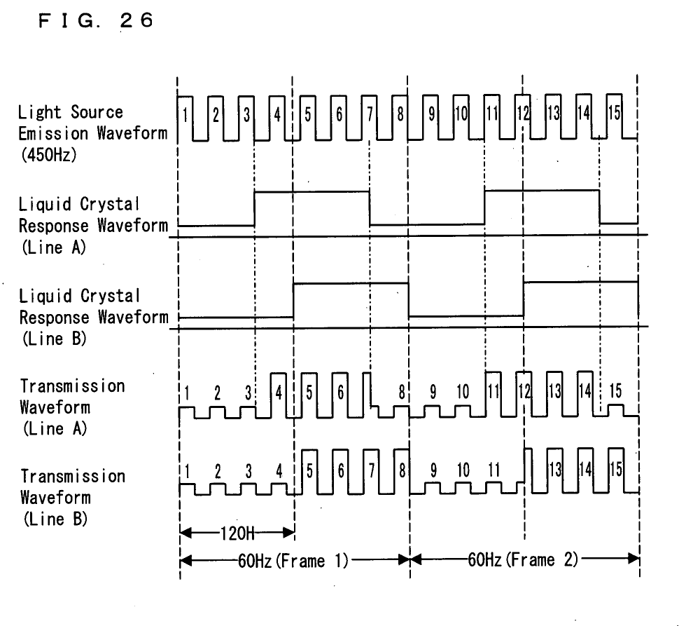

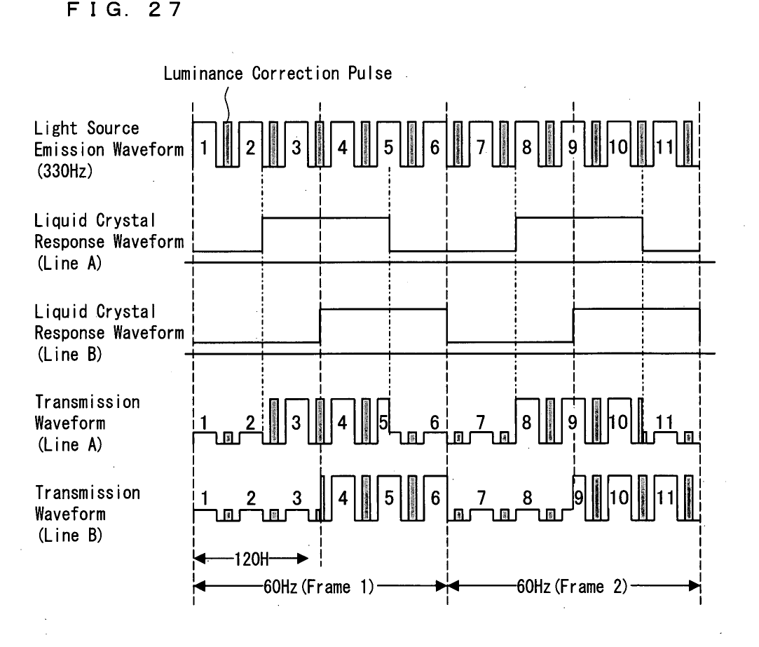

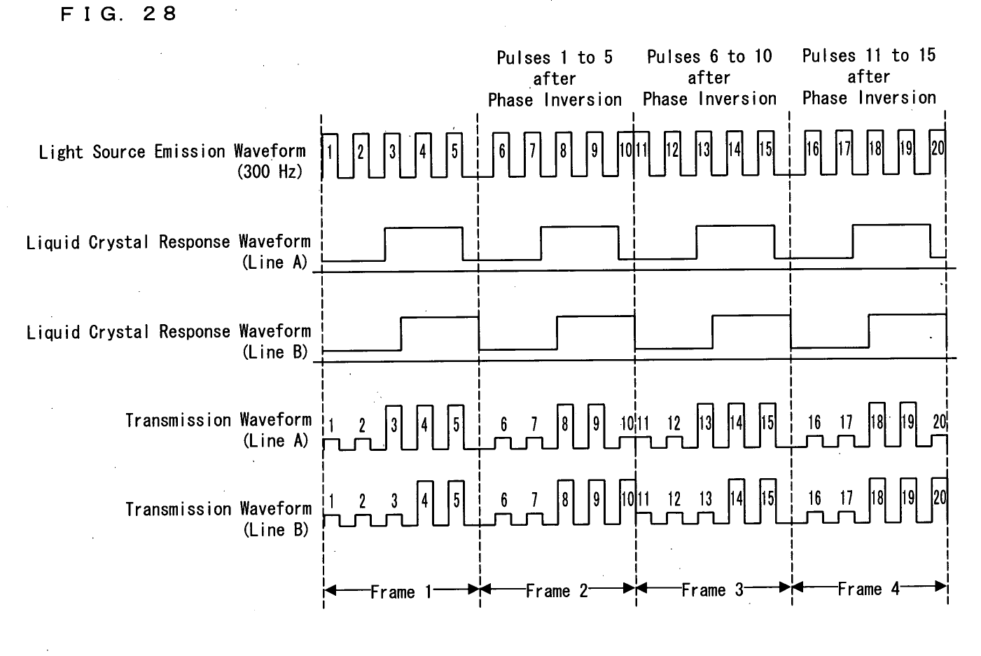

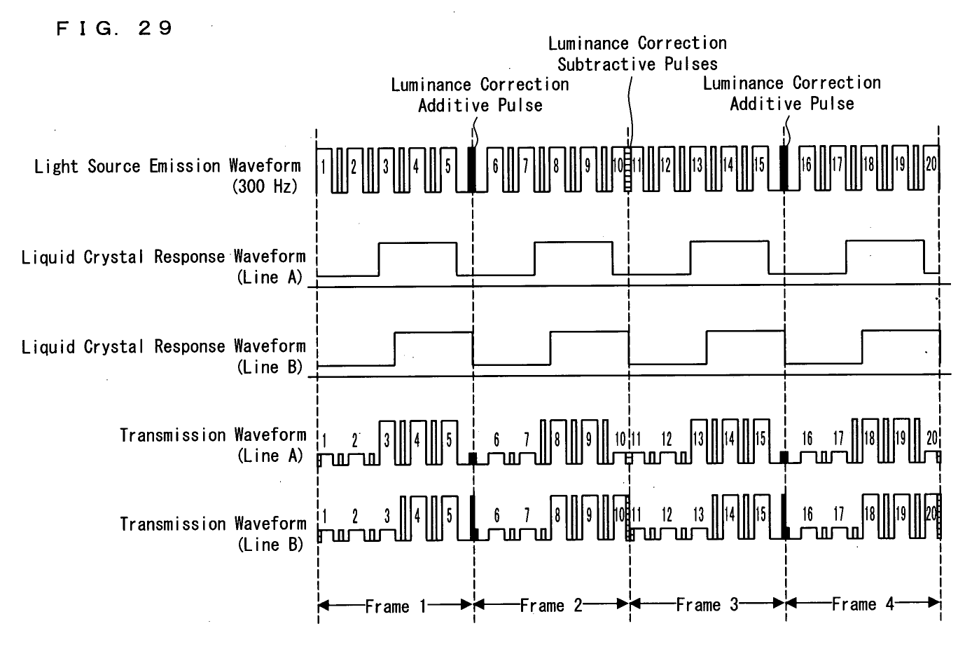

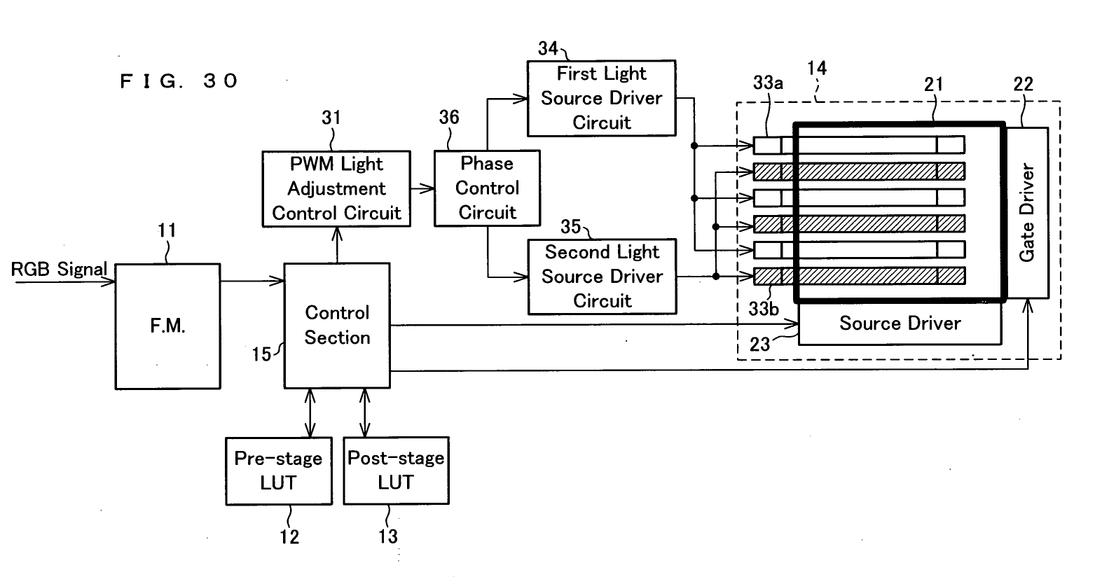

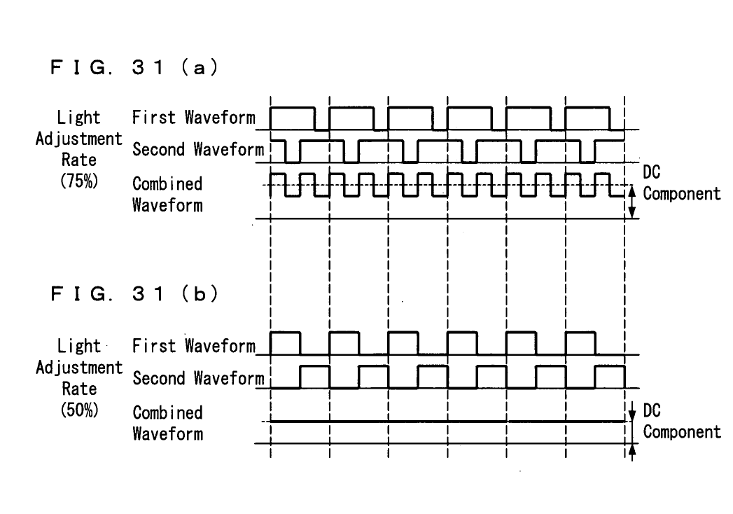

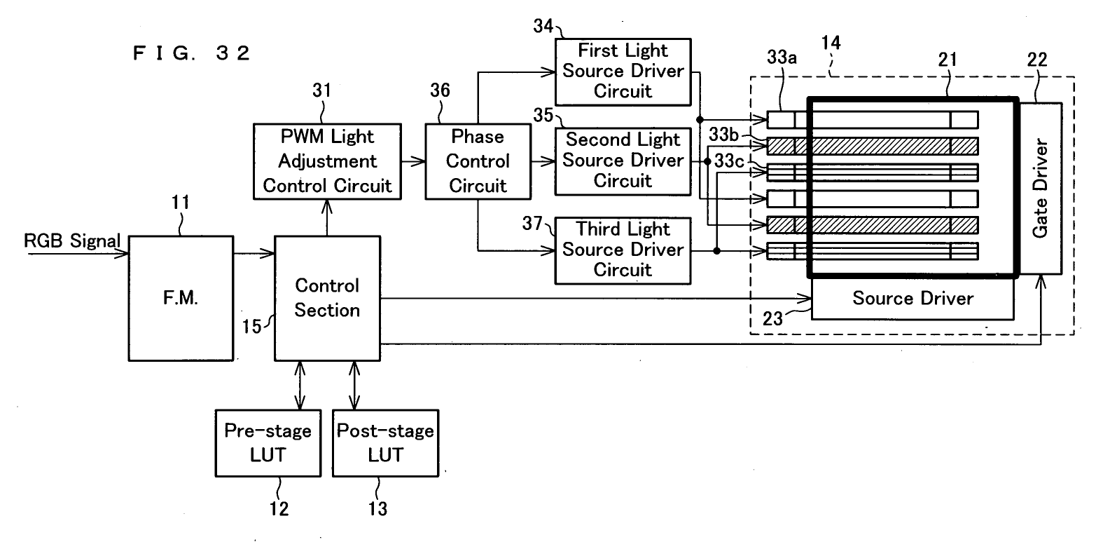

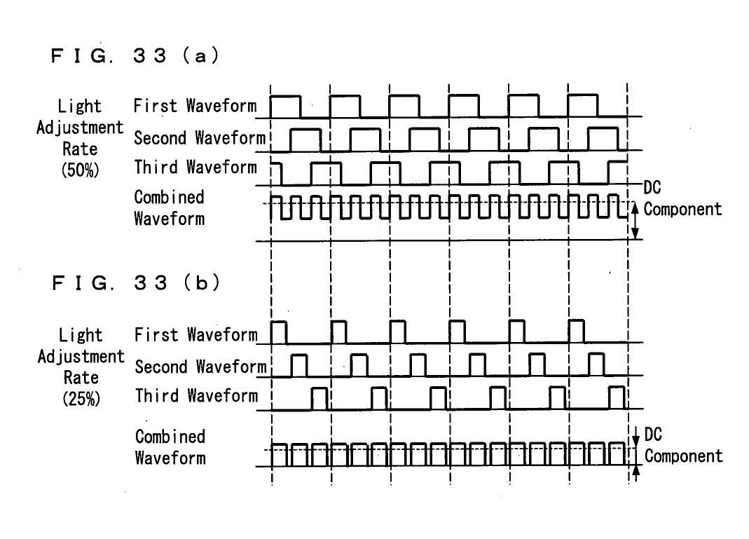

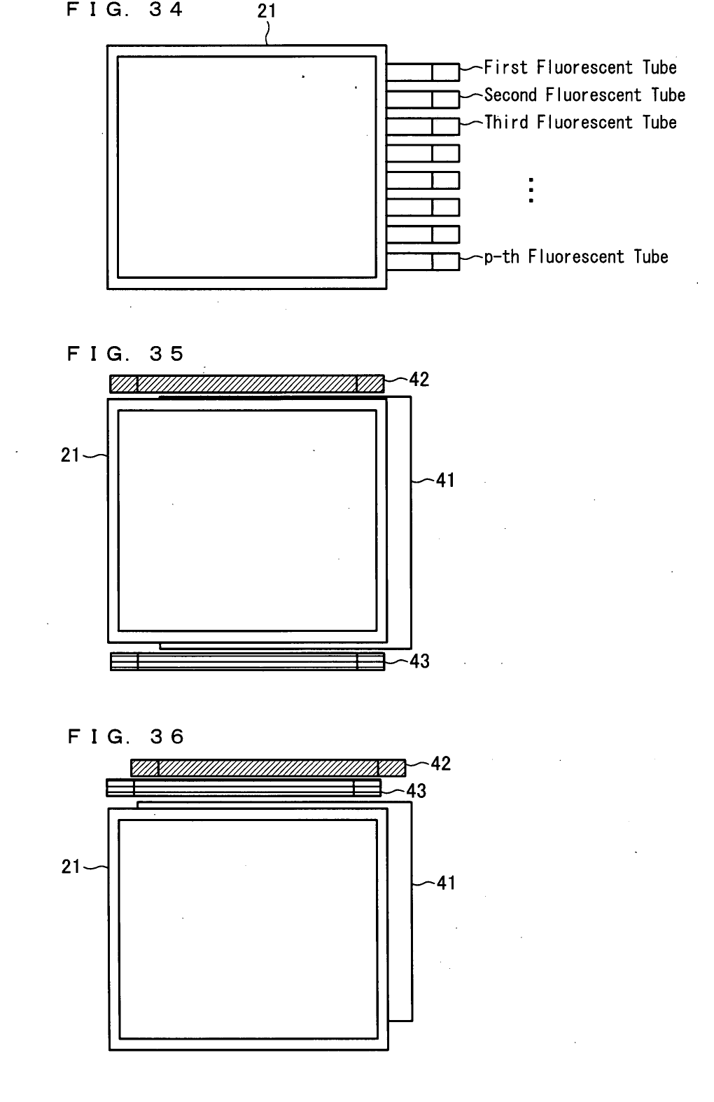

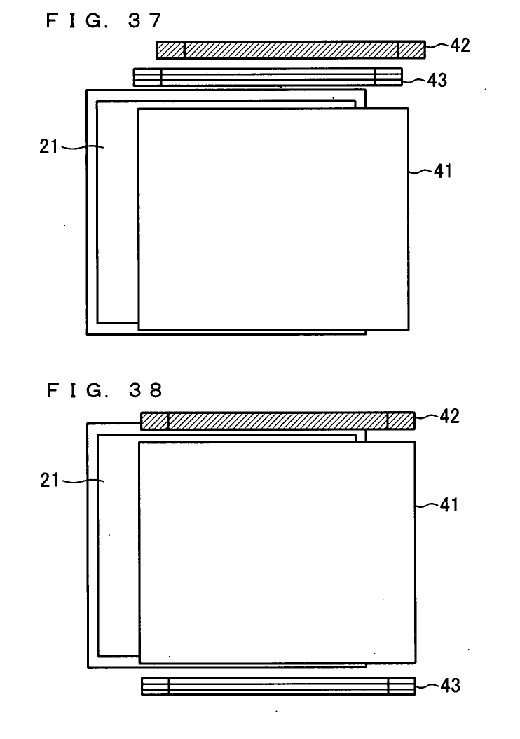

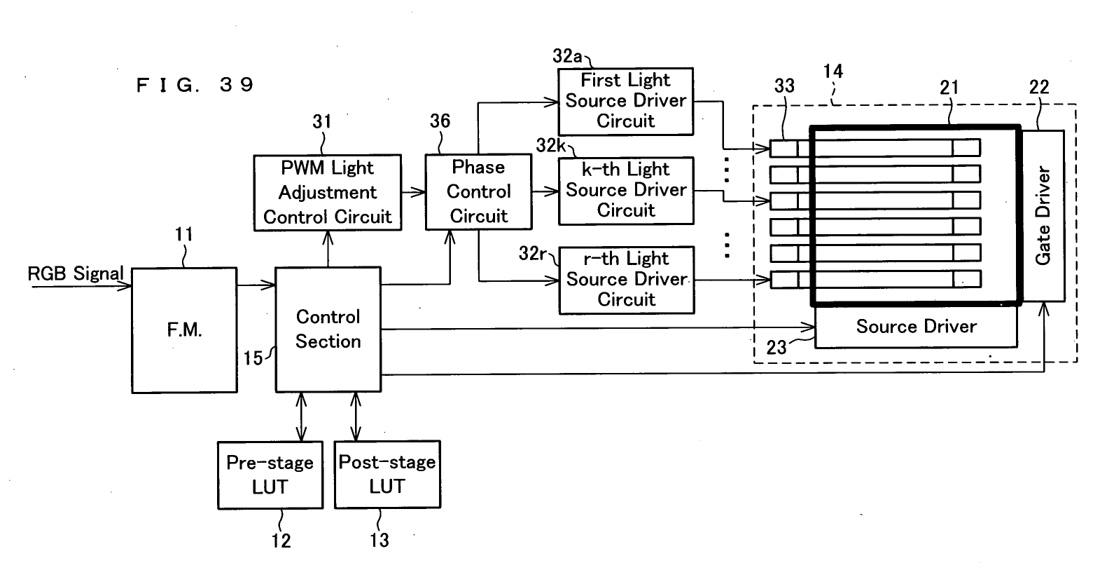

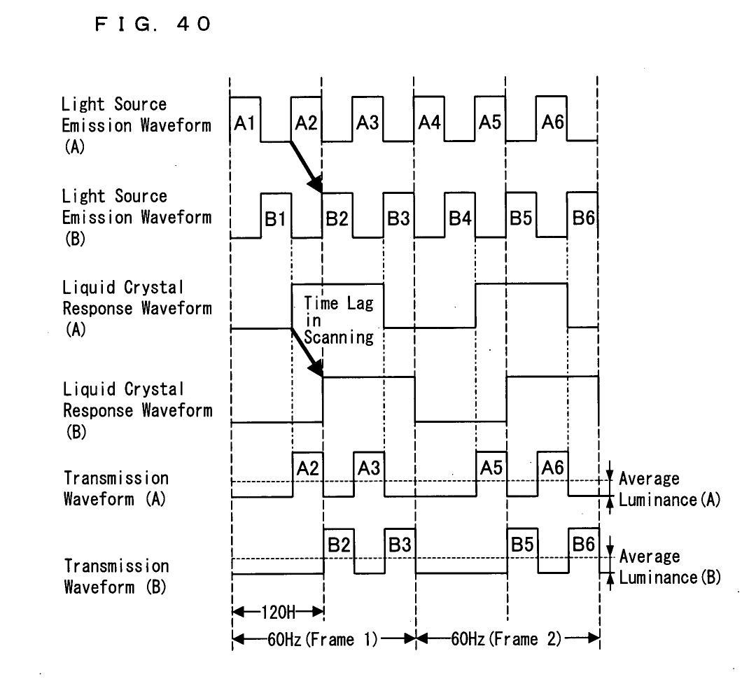

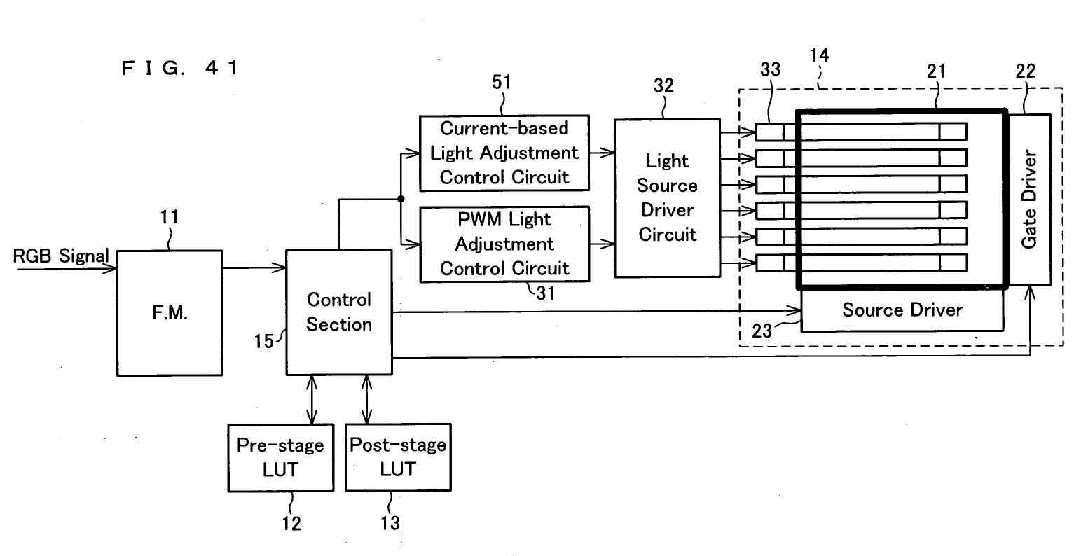

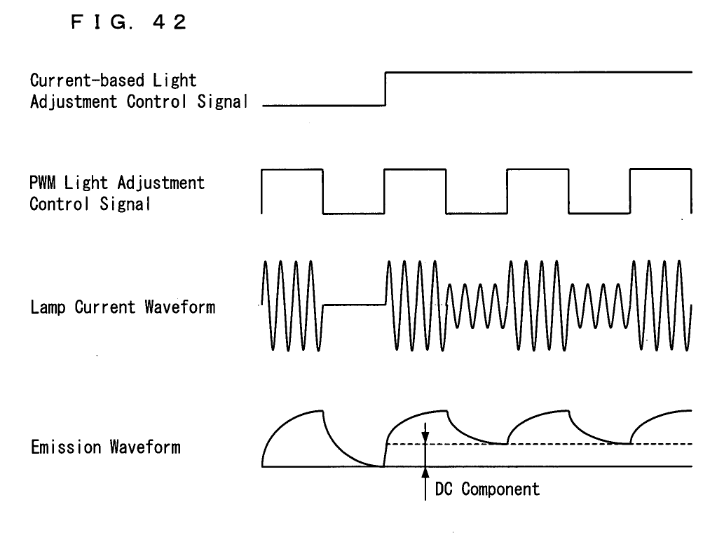

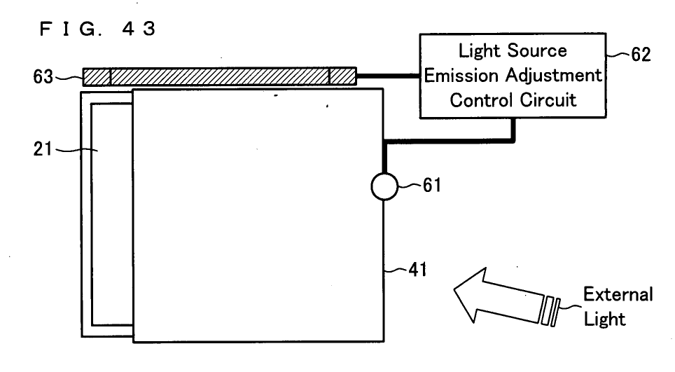

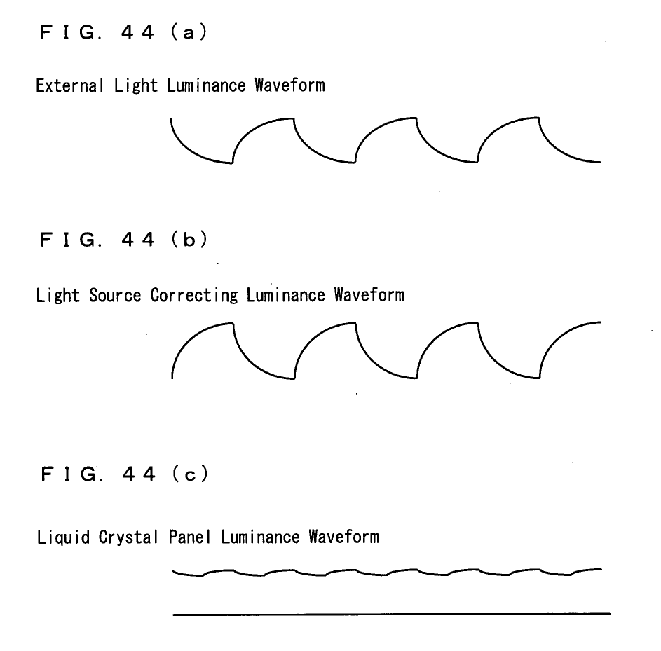

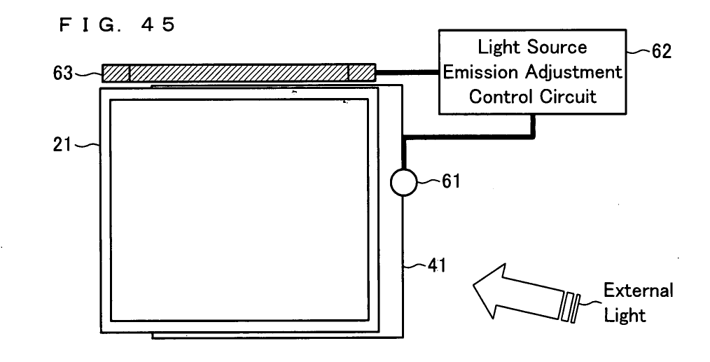

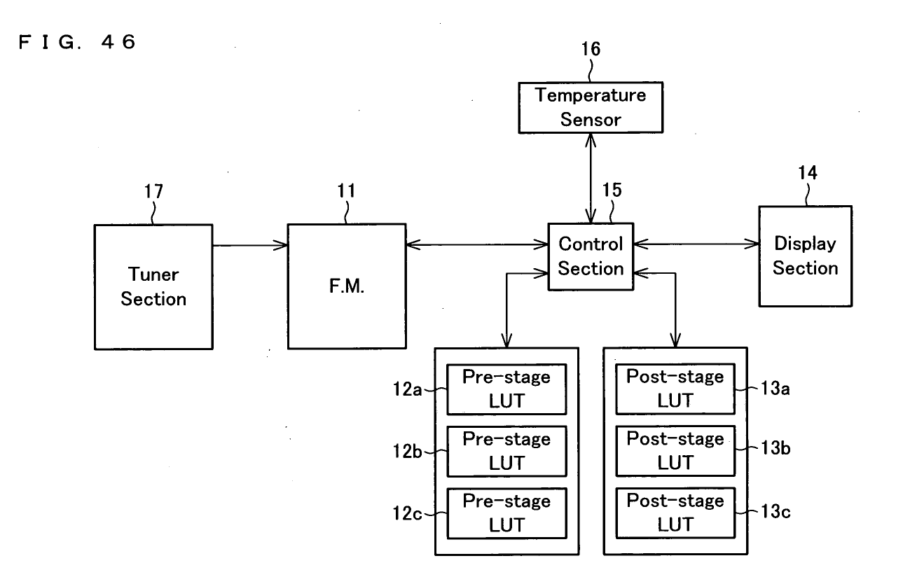

### BRIEF DESCRIPTION OF DRAWINGS

[FIG. 1] A block diagram illustrating the structure of a display device in accordance with an embodiment of the present invention.

[FIG. 2] A graph representing display luminance outputs of a liquid crystal panel (relationship between expected luminance and actual luminance) for ordinary hold display.

[FIG. 3] A graph representing display luminance outputs of a liquid crystal panel (relationship between expected luminance and actual luminance) for subframe display on the display device shown in FIG. 1.

[FIG. 4] (a) is an illustration of an image signal fed to a frame memory in the display device shown in FIG. 1. (b) is an illustration of an image signal output from the frame memory to a pre-stage LUT in a 3:1 division. (c) is an illustration of an image signal output from the frame memory to a post-stage LUT in the same 3:1 division.

[FIG. 5] An illustration of gate line ON timings in relation to a pre-stage display signal and a post-stage display signal for a 3:1 frame division on the display device shown in FIG. 1.

[FIG. 6] A brightness graph plotted by luminance-to-brightness conversion of the luminance graph in FIG. 3.

[FIG. 7] A graph representing the relationship between expected brightness and actual brightness for a 3:1 frame division on the display device shown in FIG. 1.

[FIG. 8] An illustration of a partially altered version of the structure of the display device shown in FIG. 1. [FIG. 9(a)] An illustration of a method whereby the polarity of an electrode-to-electrode voltage is reversed at a frame cycle.

[FIG. 9(b)] An illustration of a method whereby the polarity of an electrode-to-electrode voltage is reversed at a frame cycle.

[FIG. 10(a)] An illustration depicting the response rate of liquid crystal.

[FIG. 10(b)] An illustration depicting the response rate of liquid crystal.

[FIG. 10(c)] An illustration depicting the response rate of liquid crystal.

[FIG. 11] A graph representing display luminance outputs of a liquid crystal panel (relationship between expected luminance and actual luminance) for subframe display using a slow-response liquid crystal.

[FIG. 12(a)] A graph representing the luminance in a preceding subframe and a succeeding subframe for a display luminance three quarters of Lmax and a display luminance a quarter of Lmax.

[FIG. 12(b)] A graph representing transitioning of a liquid crystal driving voltage (that is, voltage applied to liquid crystal) of which the polarity is reversed at a subframe cycle.

[FIG. 13(a)] An illustration of a method whereby the polarity of an electrode-to-electrode voltage is reversed at a frame cycle.

[FIG. 13(b)] An illustration of a method whereby the polarity of an electrode-to-electrode voltage is reversed at a frame cycle.

[FIG. 14(a)] An illustration showing four pixels in a liquid crystal panel and the polarities of liquid crystal driving voltages for the pixels.

[FIG. 14(b)] An illustration showing four pixels in a liquid crystal panel and the polarities of liquid crystal driving voltages for the pixels.

[FIG. 14(c)] An illustration showing four pixels in a liquid crystal panel and the polarities of liquid crystal driving voltages for the pixels.

[FIG. 14(d)] An illustration showing four pixels in a liquid crystal panel and the polarities of liquid crystal driving voltages for the pixels.

[FIG. 15] A graph representing results of displays produced by dividing a frame equally into three subframes (broken line and solid line) and results of ordinary hold display (dash-dot line and solid line).

[FIG. 16] A graph representing transitioning of a liquid crystal driving voltage in a case where each frame is divided into three subframes and the voltage polarity is reversed from one frame to the next.

[FIG. 17] A graph representing transitioning of a liquid crystal driving voltage in a case where each frame is divided into three subframes and the voltage polarity is reversed from one subframe to the next.

[FIG. 18] A graph representing, for a subframe in which luminance is not adjusted, relationship (viewing angle grayscale characteristics (actual measurements)) between the signal grayscale level (%; luminance grayscale level represented by a display signal) output supplied to a display section and the actual luminance grayscale level (%) in accordance with that signal grayscale level.

[FIG. 19] An illustration of current-based light adjustment.

[FIG. 20] An illustration of PWM light adjustment.

[FIG. 21] A graph representing examples of a light adjustment signal waveform, a lamp current waveform, and an emission waveform (waveform of light output of a fluorescent tube) when a fluorescent tube is used as a light source.

[FIG. 22] A block diagram illustrating the internal structure of a display device for PWM light adjustment in accordance with the present invention.

[FIG. 23] A graph representing an example of relationship between a light source emission waveform, a waveform for an electrode-to-electrode voltage of a liquid crystal (liquid crystal response waveform), and a waveform of light transmitted by liquid crystal (transmission waveform) when PWM light adjustment is used in combination with ordinary hold display.

[FIG. 24] A graph representing the same kinds of waveforms when PWM light adjustment is used in combination with subframe display (for low luminance).

[FIG. 25] A graph representing an example of relationship between a light source emission waveform, liquid crystal response waveforms, and transmission waveforms when PWM light adjustment is used in combination with subframe display.

[FIG. 26] A graph representing an example of relationship between a light source emission waveform, liquid crystal response waveforms, and transmission waveforms when the light adjustment frequency is set to a value n.5 times the frame frequency, the value being more than or equal to 450 Hz.

[FIG. 27] A graph representing an example of relationship between a light source emission waveform, liquid crystal response waveforms, and transmission waveforms when luminance correction pulses are used.

[FIG. 28] A graph representing an example of relationship between a light source emission waveform, liquid crystal response waveforms, and transmission waveforms when the phase of the light source emission waveform is inverted for each frame.

[FIG. 29] A graph representing an example of relationship between a light source emission waveform, liquid crystal response waveforms, and transmission waveforms when the phase of the light source emission waveform is inverted for each frame and positive correction pulses and negative correction pulses are added.

[FIG. 30] A block diagram illustrating the structure of a display device when a light source emission waveform is controlled so as to include a DC component.

[FIG. 31] (a), (b) are graphs representing an example of an emission waveform for a first fluorescent tube (first waveform), an emission waveform for a second fluorescent tube (second waveform), and a combined waveform of the emission waveforms for the two fluorescent tubes (combined waveform) in the structure shown in FIG. 30.

[FIG. 32] A block diagram illustrating the structure of a display device in which fluorescent tubes are classified into 3 types and each type is controlled independently.

[FIG. 33] (a), (b) are graphs representing an example of waveforms for fluorescent tubes (first to third waveforms) and a combined waveform of these waveforms (combined waveform) in the structure shown in FIG. 30.

[FIG. 34] An illustration of the structure of a liquid crystal display element with direct backlights.

[FIG. 35] An illustration of the structure of a backlight-type liquid crystal display element with two LEDs as light sources disposed on two sides of each light guide.

[FIG. 36] An illustration of the structure of a backlight-type liquid crystal display element with two LEDs as light sources disposed on one side of each light guide.

[FIG. 37] An illustration of the structure of a frontlight-type liquid crystal display element with two LEDs as light sources disposed on two sides of each light guide.

[FIG. 38] An illustration of the structure of a frontlight-type liquid crystal display element with two LEDs as light sources disposed on one side of each light guide.

[FIG. 39] A block diagram illustrating the structure of a display device in which the fluorescent tube illuminates in synchronism with the gate line in the liquid crystal panel being turned on.

[FIG. 40] A graph representing an example of relationship between light source emission waveforms, liquid crystal response waveforms, and transmission waveforms for the display device shown in FIG. 39.

[FIG. 41] A block diagram illustrating the structure of a display device which uses a combination of PWM light adjustment and current-based light adjustment.

[FIG. 42] A graph representing examples of a current-based light adjustment control signal, a PWM light adjustment control signal, a lamp current, and an emission waveform for the display device shown in FIG. 41.

[FIG. 43] An illustration of the structure of a reflective display device which implements light source control in accordance with external light.

[FIG. 44(a)] A graph representing a luminance waveform for external light incident to the display device shown in FIG. 43.

[FIG. 44(b)] A graph representing a light source emission waveform in the display device shown in FIG. 43.

[FIG. 44(c)] A graph representing a waveform for light incident to the liquid crystal panel of the display device shown in FIG. 43.

[FIG. 45] An illustration of the structure of a transflective-type display device which implements light source control in accordance with external light.

[FIG. 46] An illustration of the structure of a liquid crystal television including the display device shown in FIG. 8.

### BEST MODE FOR CARRYING OUT INVENTION

The following will describe an embodiment of the present invention.

A liquid crystal display of the present embodiment (present display device) has a liquid crystal panel of vertical alignment (VA) mode divided into a plurality of domains. The present display device functions as a liquid crystal monitor producing a display on a liquid crystal panel from externally supplied image signals.

FIG. 1 is a block diagram illustrating the internal structure of the present display device. As shown in the figure, the present display device includes a frame memory (F.M.) 11, a pre-stage LUT 12, a post-stage LUT 13, a display section 14, and a control section 15.

The frame memory (image signal feeder section) 11 stores a frame of image signals (RGB signals) fed from an external signal source. The pre-stage LUT (look-up table) 12 and the post-stage LUT 13 is an association table (conversion table) between external image signal inputs and display signal outputs to the display section 14.

The present display device is adapted to carry out subframe display. Subframe display is a method of producing a display by dividing each frame into a plurality of subframes.

In other words, the present display device is designed to produce a display from a frame of image signals fed in one frame period, by means of two subframes of the same size (period) at double the frequency.

The pre-stage LUT 12 is an association table for display signal outputs made in a pre-stage subframe (preceding subframe or second subframe). That display signal may be referred to as the pre-stage display signal or the second display signal. The post-stage LUT 13 is an association table for display signal outputs made in a post-stage subframe (succeeding subframe or first subframe). That display signal may be referred to as the post-stage display signal or the first display signal.

The display section 14 includes a liquid crystal panel 21, a gate driver 22, and a source driver 23 as shown in FIG. 1. The display section 14 produces an image display from incoming display signals. The liquid crystal panel 21 is an active matrix (TFT) liquid crystal panel of VA mode.

The control section 15 is a central processing unit of the present display device, controlling all operations in the present display device. The control section 15 generates display signals from the image signals stored in the frame memory 11 using the pre-stage LUT 12 and the post-stage LUT 13 and supplies the signals to the display section 14.

In other words, the control section 15 records the image signals that are incoming at an ordinary output frequency (ordinary clock; for example, 25 MHz) into the frame memory 11. The control section 15 then outputs twice the image signals from the frame memory 11 in accordance with a clock with double the frequency of the ordinary clock (double clock; 50 MHz).

The control section 15 generates pre-stage display signals from first image signal outputs using the pre-stage LUT 12. Thereafter, the control section 15 generates post-stage display signals from second image signal outputs using the post-stage LUT 13. The display signals are fed to the display section 14 in a sequential manner in accordance with the double clock.

Accordingly, the display section 14 displays, once in every frame period, different images from the two sequentially fed display signals (all the gate lines of the liquid crystal panel 21 are turned on once in each of the two subframe periods). Display signal output operation will be described later in more detail.

Next will be described the generation of the pre-stage display signals and the post-stage display signals by the control section 15. First, the following will describe typical display luminance (luminance of an image display produced on a panel) in relation with the liquid crystal panel.

When an image is displayed from ordinary 8-bit data over a single frame, without using subframes (ordinary hold display in which all the gate lines of the liquid crystal panel are turned on only once in every frame period), a display signal represents luminance grayscale levels (signal grayscale levels) 0 to 255.

The signal grayscale levels and the display luminance of a liquid crystal panel are related approximately by equation 1 below:

((T−T0)/(Tmax−T0))=(L/Lmax)̂γ (1)

where L is a signal grayscale level in ordinary hold display in which an image is displayed over a frame (frame grayscale level), Lmax is a maximum luminance grayscale level (=255), T is a display luminance, Tmax is a maximum luminance (luminance when L=Lmax=255; white), T0 is a minimum luminance (luminance when L=0; black), and γ is a correction value (typically, 2.2). In the case of an actual liquid crystal panel 21, T0≠0. Let us assume in the following, however, that T0=0 for simple description.

The display luminance T output of the liquid crystal panel 21 in the above case (ordinary hold display) is drawn in the graph in FIG. 2. In the graph, the expected luminance output (expected luminance; value in accordance with a signal grayscale level, equivalent to the display luminance T) is plotted on the horizontal axis. The actual luminance output (actual luminance) is plotted on the vertical axis.

As can be seen from the graph, in this case, the two luminances are equal to each other when the liquid crystal panel 21 is viewed from the front (that is, viewing angle=0°). In contrast, when the viewing angle is set to 60°, the actual luminance increases at halftone luminance due to changes in grayscale γ-characteristics.

Next, the display luminance of the present display device will be described. In the present display device, the control section 15 is designed to with such grayscale display capability that it can satisfy conditions (a) and (b):
(a) The total sum of the luminances (display luminances) of the images displayed by the display section 14 in the individual preceding and succeeding subframes (integral luminance over one frame) equals the display luminance over one frame in ordinary hold display; and
(b) One of the subframes is either black (minimum luminance) or white (maximum luminance).

To achieve this, the present display device is designed so that the control section 15 can equally divide a frame into two subframes in one of which the display luminance reaches half a maximum luminance.

In other words, in a case where the luminance reaches half the maximum luminance (threshold luminance; Tmax/2) in one frame (in a low luminance case), the control section 15 designates the preceding subframe for a minimum luminance (black) and adjusts the display luminance in only the succeeding subframe (using only the succeeding subframe) to achieve a grayscale display. In a case like this, the integral luminance over one frame equals (minimum luminance+luminance in the succeeding subframe)/2.

In a case of outputting a higher luminance than the threshold luminance (in a high luminance case), the control section 15 designates the succeeding subframe for a maximum luminance (white) and adjusts the display luminance in the preceding subframe to achieve a grayscale display.

In a case like this, the integral luminance over one frame equals (luminance in the preceding subframe+maximum luminance)/2.

Now, the following will specifically describe such signal grayscale level settings for the display signals (pre-stage display signal and post-stage display signal) that this particular display luminance is achieved. The signal grayscale level settings are made by the control section 15 shown in FIG. 1. The control section 15 calculates in advance a frame grayscale level corresponding to the threshold luminance (Tmax/2) by equation 1.

In other words, rearranging equation 1, the frame grayscale level (threshold luminance grayscale level; Lt) which is in accordance with the display luminance is given by:

Lt=0.5̂(1/γ)×Lmax (2)

where Lmax=Tmax̂γ (2a)

When displaying an image, the control section 15 calculates the frame grayscale level L from the image signal output of the frame memory 11.

If L≦Lt, the control section 15 controls the pre-stage LUT 12 to set the luminance grayscale level represented by the pre-stage display signal (termed F) to a minimum (0). Meanwhile, the control section 15 controls the post-stage LUT 13 to set the luminance grayscale level represented by the post-stage display signal (termed R) by equation 1 so that

R=0.5̂(1/γ)×L (3)

If the frame grayscale level L>Lt, the control section 15 sets the luminance grayscale level represented by the post-stage display signal R to a maximum (255). Meanwhile, the control section 15, using equation 1, sets the luminance in the preceding subframe grayscale level F to:

F=(L̂γ−0.5×Lmax̂γ)̂(1/γ) (4)

Next, display signal output operation by the present display device will be described in more detail. In the following, the liquid crystal panel 21 is assumed to have a×b pixels. In a case like this, the control section 15 stores in the source driver 23 the pre-stage display signals for the a pixels on the first gate lines in accordance with the double clock.

The control section 15 controls the gate driver 22 to turn on the first gate lines to write a pre-stage display signal to the pixels on the gate lines. Thereafter, The control section 15 similarly turns on the second to b-th gate lines in accordance with the double clock, while changing the pre-stage display signals to be stored in the source driver 23. Accordingly, the pre-stage display signals for all the pixels can be written within half the frame period (½ frame period).

Furthermore, the control section 15 performs a similar operation to write a post-stage display signal to the pixels on all the gate lines within the remaining half of the frame period. Accordingly, a pre-stage display signal and a post-stage display signal are written to each pixel taking up equal times (=½ frame period).

FIG. 3 is a graph representing results of such subframe display (broken line and solid line) in which the pre-stage display signal outputs and the post-stage display signal outputs are divided between the preceding and succeeding subframes, together with the results (dash-dot line and solid line) shown in FIG. 2.

The present display device uses a liquid crystal panel 21 in which, as shown in FIG. 2, the discrepancy of the actual luminance from the expected luminance (equivalent to the solid line) at large viewing angles is a minimum (0) when the display luminance is either a minimum or a maximum and a maximum at halftones (threshold luminance proximity).

The present display device performs subframe display in which each frame is divided into subframes. Furthermore, the two subframes are set up to have equal durations. At low luminances, only the succeeding subframe is used to produce a display, with the preceding subframe being designated for black display, so long as the integral luminance over one frame does not change. Therefore, the discrepancy in the preceding subframe is reduced to a minimum. Thus, the total discrepancy in the two subframes can be reduced to about half as indicated by the broken line in FIG. 3.

On the other hand, at high luminances, the luminance in only the preceding subframe is adjusted to produce a display, with the succeeding subframe being designated for white display, so long as the integral luminance over one frame does not change. Therefore, the discrepancy in the succeeding subframe is reduced similarly to a minimum in this case. The total discrepancy in the two subframes can be reduced to about half as indicated by the broken line in FIG. 3.

As explained above, the present display device is capable of reducing overall discrepancy to about half that for structures for ordinary hold display (structures in which an image is displayed over a single frame, without using subframes). That reduces brightness/excess brightness in halftone images (excess brightness phenomenon) shown in FIG. 2.

In the present embodiment, the duration of the preceding subframe is made equal to that of the succeeding subframe. This is for the purpose of achieving half the maximum luminance in one subframe. The subframe durations, however, may be set to different values.

The excess brightness phenomenon, an issue to be addressed by the present display device, is a phenomenon in which a halftone luminance image appears excessively bright because of the characteristics of the actual luminance at large viewing angles as shown in FIG. 2.

Normally, an image captured on a camera is represented by luminance signals. To transmit the image in digital format, the image is converted to display signals using γ shown in equation 1 (in other words, luminance signals are raised to the (1/γ)-th power and equally divided to assign grayscale levels). The image displayed on a liquid crystal panel or like display device from these display signals has the display luminance given by equation 1.

The human eye perceives an image by brightness, not by luminance. Brightness (brightness index) M is given by equations/inequalities (5), (6) (see Non-patent Document 1):

M=116×Ŷ(⅓)−16, Y>0.008856 (5)

M=903.29×Y, Y≦0.008856 (6)

where Y is equivalent to the actual luminance explained above and given by Y=(y/yn), y denotes the y value of tristimulus values of a given color in the xyz color system, and yn denotes the y value by standard light on a total diffusing reflective face and is defined as yn=100.

The equations/inequalities indicate that the human eye tends to be sensitive to low luminance video and insensitive to high luminance video. A human being presumably perceives excess brightness as discrepancy in brightness, not discrepancy in luminance.

FIG. 6 is a graph plotted by luminance-to-brightness conversion of the luminance graph in FIG. 3. In the graph, the expected brightness output (expected brightness; a value in accordance with a signal grayscale level, equivalent to the brightness M) is plotted on the horizontal axis. The actual brightness output (actual brightness) is plotted on the vertical axis. As indicated by the solid line in the graph, the two levels of brightness are equal to each other when the liquid crystal panel 21 is viewed from the front (that is, viewing angle=0°).

In contrast, as indicated by the broken line in the graph, when the viewing angle is set to 60° and the durations of all the subframes are equal (in other words, when half the maximum luminance is reached within one subframe), the discrepancy of the actual brightness from the expected brightness is improved, albeit not much, over conventional cases of ordinary hold display. That demonstrates that the excess brightness phenomenon is somewhat mitigated.

For further mitigating the excess brightness phenomenon in a manner that suits human vision, it is more preferable to determine frame division ratios in accordance with brightness, not with luminance. The discrepancy of the actual brightness from the expected brightness is a maximum when the expected brightness is half the maximum value similarly to the case of luminance.

Therefore, the discrepancy as perceived by the human eye (that is, excess brightness) is reduced better by dividing a frame so that half the maximum brightness is reached within one subframe than by dividing a frame so that half the maximum luminance is reached within one subframe.

Accordingly, the following will describe desirable values at frame dividing points. First, for ease in calculation, equations/inequalities (5), (6) introduced above are approximated by equation (6a) which is derived by combining and rearranging (5), (6). Equation (6a) has a similar form to equation 1.

M=Ŷ(1/α) (6a)

In this form of the equation, α≈2.5.

The luminance Y and brightness M as given in equation (6a) has a proper relationship (suitable to human vision) if α is from 2.2 to 3.0.

It is known that the durations of the two subframes is preferably about 1:3 if γ=2.2 and about 1:7 if γ=3.0 to produce a display at half the maximum brightness M in one subframe. When the frame is divided as in above, one of the subframes which is used for display when luminance is low (the one maintained at a maximum luminance in a high luminance case) is the shorter period.

The following will describe a case where the ratio of the preceding subframe and the succeeding subframe is set to 3:1. First, display luminance in the case will be described.

In this case, to produce a low luminance display in which a quarter of a maximum luminance (threshold luminance; Tmax/4) is achieved in one frame, the control section 15 designates the preceding subframe for a minimum luminance (black) and adjusts the display luminance in only the succeeding subframe to produce a grayscale display (uses only the succeeding subframe to produce a grayscale display). The integral luminance over one frame here equals (minimum luminance+luminance in the succeeding subframe)/4.

To achieve a higher luminance than the threshold luminance (Tmax/4) in one frame (in a high luminance case), the control section 15 designates the succeeding subframe for a maximum luminance (white) and adjusts the display luminance in the preceding subframe to produce a grayscale display. The integral luminance over one frame here equals (luminance in the preceding subframe+maximum luminance)/4.

Now, the following will specifically describe such signal grayscale level settings for the display signals (pre-stage display signal and post-stage display signal) that this particular display luminance is achieved. The signal grayscale levels (and output operation which will be detailed later) in this case are also set so as to meet conditions (a), (b).

First, the control section 15 calculates in advance a frame grayscale level corresponding to the threshold luminance (Tmax/4) by equation 1.

In other words, rearranging equation 1, the frame grayscale level (threshold luminance grayscale level; Lt) which is in accordance with the display luminance is given by:

Lt=(¼)̂(1/γ)×Lmax (7)

When displaying an image, the control section 15 calculates the frame grayscale level L from the image signal output of the frame memory 11. If L≦Lt, the control section 15 controls the pre-stage LUT 12 to set the luminance grayscale level represented by the pre-stage display signal (termed F) to a minimum (0).

Meanwhile, the control section 15 controls the post-stage LUT 13 to set the luminance grayscale level represented by the post-stage display signal (termed R) by equation 1 so that

R=(¼)̂(1/γ)×L (8)

If the frame grayscale level L>Lt, the control section 15 sets the luminance grayscale level represented by the post-stage display signal R to a maximum (255). Meanwhile, the control section 15, using equation 1, sets the luminance in the preceding subframe grayscale level F to:

F=((L̂γ−(¼)×Lmax̂γ))̂(1/γ) (9)

Next, the output operation for the pre-stage display signal and the post-stage display signal will be described. As explained above, in an equal frame division structure, a pre-stage display signal and a post-stage display signal are written to each pixel over equal durations (½ frame period). This is because in order to write the post-stage display signals after all the pre-stage display signals are written in accordance with the double clock, those gate lines which are related to the display signals are turned on for equal periods.

Therefore, the division ratios can be changed by changing the timings at which to start writing the post-stage display signals (gate ON timings related to the post-stage display signals).

FIG. 4(a) is an illustration of an image signal fed to the frame memory 11. FIG. 4(b) is an illustration of another image signal supplied from the frame memory 11 to the pre-stage LUT 12 when the division ratio is 3:1. FIG. 4(c) is an illustration of another image signal supplied to the post-stage LUT 13 in the same manner. FIG. 5 is an illustration of gate line ON timings in relation to the post-stage display signal and the pre-stage display signal when the division ratio is 3:1 as above.

As depicted in these figures, in this case, the control section 15 writes a pre-stage display signal for the first frame to the pixels on the gate lines in accordance with the ordinary clock. Then, after three quarters of the frame period, the control section 15 starts writing a post-stage display signal. From this moment on, a pre-stage display signal and a post-stage display signal are written alternately in accordance with the double clock.

In other words, after writing a pre-stage display signal to the pixels on the first three quarters of all the gate lines, the post-stage display signal associated with the first gate line is stored in the source driver 23, and that gate line is turned on. Next, the pre-stage display signal associated with the gate line that immediately follows the first three quarters of all the gate lines is stored in the source driver 23, and that gate line is turned on.

This configuration of alternately outputting the pre-stage display signals and the post-stage display signals in accordance with the double clock after three quarters of the first frame enables the division ratio setting for the preceding subframe and the succeeding subframe to 3:1. The total display luminance over these two subframes (integral sum) equals the integral luminance over one frame. The data stored in the frame memory 11 is supplied to the source driver 23 in accordance with gate timings.

FIG. 7 a graph representing a relationship between the expected brightness and the actual brightness when the frame division ratio is 3:1. As shown in FIG. 7, in this configuration, the frame is divided where the discrepancy of the actual brightness from the expected brightness is the largest. Therefore, the difference between the expected brightness and the actual brightness is very small in the case of viewing angle=60° when compared to the results shown in FIG. 6.

In other words, the present display device, in the case of low luminance (low brightness) up to Tmax/4, designates the preceding subframe for black display and uses only the succeeding subframe to produce a display so long as the integral luminance over one frame does not change. Therefore, the discrepancy in the preceding subframe (the difference between the actual brightness and the expected brightness) is reduced to a minimum; the total discrepancy in the two subframes can be reduced to about half as indicated by the broken line in FIG. 7.

In contrast, in a high luminance (high brightness) case, the luminance in only the preceding subframe is adjusted to produce a display, with the succeeding subframe being designated for white display, so long as the integral luminance over one frame does not change. Therefore, the discrepancy in the succeeding subframe in this case is reduced again to a minimum; the total discrepancy in the two subframes can be reduced to about half as indicated by the broken line in FIG. 7.

As explained above, the present display device is capable of reducing overall brightness discrepancy to about half that for structures for ordinary hold display. That more effectively reduces brightness/excess brightness in halftone images (excess brightness phenomenon) shown in FIG. 2.

In the above description, the pre-stage display signal for the first frame written to the pixels on the gate lines in accordance with the ordinary clock in the first three quarters of the frame period since the display is started. This is because a timing is yet to come to write the post-stage display signals.

An alternative approach is to use dummy post-stage display signals so that a display may be produced in accordance with the double clock since the display is started. In other words, a pre-stage display signal and a post-stage display signal with signal grayscale level 0 (dummy post-stage display signal) may be alternately output in the first three quarters of the frame period since the display is started.

Now, the following will describe a more general case where the ratio of the preceding subframe and the succeeding subframe equals n:1. In that case, the control section 15, to achieve a luminance 1/(n+1) times the maximum luminance (threshold luminance; Tmax/(n+1)) in one frame (in a low luminance case), designates the preceding subframe for a minimum luminance (black) and adjusts the display luminance in only the succeeding subframe to produce a grayscale display (only the succeeding subframe is used to produce a grayscale display). The integral luminance over one frame here equals (minimum luminance+luminance in the succeeding subframe)/(n+1).

To achieve a higher luminance than the threshold luminance (Tmax/(n+1)) (in a high luminance case), the control section 15 designates the succeeding subframe for a maximum luminance (white) and adjusts the display luminance in the preceding subframe to produce a grayscale display. The integral luminance over one frame here equals (luminance in the preceding subframe+maximum luminance)/(n+1).

Now, the following will specifically describe such signal grayscale level settings for the display signals (pre-stage display signal and post-stage display signal) that this particular display luminance is achieved. The signal grayscale levels (and output operation which will be detailed later) in this case are also set so as to meet conditions (a), (b).

First, the control section 15 calculates in advance a frame grayscale level corresponding to the threshold luminance (Tmax/(n+1)) by equation 1.

In other words, rearranging equation 1, the frame grayscale level (threshold luminance grayscale level; Lt) which is in accordance with the display luminance is given by:

Lt=(1/(n+1))̂(1/γ)×Lmax (10)

When displaying an image, the control section 15 calculates the frame grayscale level L from the image signal output of the frame memory 11. If L≦Lt, the control section 15 controls the pre-stage LUT 12 to set the luminance grayscale level represented by the pre-stage display signal (termed F) to a minimum (0).

Meanwhile, the control section 15 controls the post-stage LUT 13 to set the luminance grayscale level represented by the post-stage display signal (termed R) by equation 1 so that

R=(1/(n+1))̂(1/γ)×L (11)

If the frame grayscale level L>Lt, the control section 15 sets the luminance grayscale level represented by the post-stage display signal R to a maximum (255). Meanwhile, the control section 15, using equation 1, sets the luminance in the preceding subframe grayscale level F to:

F=((L̂γ−(1/(n+1))×Lmax̂γ))̂(1/γ) (12)

The display signal output operation for a 3:1 frame division needs only to be designed to start alternately outputting the pre-stage display signals and the post-stage display signals in accordance with the double clock when the first n/(n+1) of the first frame has elapsed.

The equal frame division structure could be described as below. A frame is divided into 1+n (=1) subframe periods. Pre-stage display signals are output in one subframe period in accordance with a clock 1+n (=1) times an ordinary clock. Post-stage display signals are output continuously in the last n (=1) subframe periods.

This structure however needs a very fast clock when n≧2 and adds to device cost. Therefore, the structure explained above in which the pre-stage display signals and the post-stage display signals are alternately output is preferred when n≧2. In this case, the ratio of the preceding subframe and the succeeding subframe can be set to n:1 by adjusting the output timings of the post-stage display signals. Therefore, the necessary clock frequency can be maintained at double the ordinary frequency.

In the present embodiment, the control section 15 converts the image signals to the display signals in the pre-stage LUT 12 and the post-stage LUT 13. The present display device may include more than one pre-stage LUTs 12 and post-stage LUTs 13.

FIG. 8 shows a modification to the structure shown in FIG. 1 in which the pre-stage LUT 12 is replaced with three pre-stage LUTs 12a to 12c and the post-stage LUT 13 is replaced with three post-stage LUTs 13a to 13c. The structure also includes a temperature sensor 16.

The liquid crystal panel 21 changes its response characteristics and grayscale luminance characteristics depending on ambient temperature (temperature of the environment in which the display section 14 sits). That causes the optimal display signals in accordance with the image signals to change with the ambient temperature.

The pre-stage LUTs 12a to 12c are suitable for use in mutually different temperature ranges. Likewise, the post-stage LUTs 13a to 13c are suitable for use in mutually different temperature ranges.

The temperature sensor 16 measures the ambient temperature of the present display device and supplies results of the measurement to the control section 15.

In this structure, the control section 15 is designed to switch between the LUTs based on the ambient temperature information supplied by the temperature sensor 16. Therefore, the structure is capable of providing display signals more suitable to the image signals to the liquid crystal panel 21. That enables image display with higher fidelity luminance throughout the anticipated temperature range (for example, from 0° C. to 65° C.).

Furthermore, the liquid crystal panel 21 is preferably AC driven because AC driving enables switching of pixel charge polarity (polarity of the voltage across pixel electrodes sandwiching liquid crystal (electrode-to-electrode voltage)) for each frame.

DC driving applies biased voltage across the electrodes and causes electric charge to accumulate between the electrodes. If the condition continues, potential difference persists between electrodes (generally called an “etching” or “burn-in” phenomenon) even in the absence of voltage application.

In subframe display as carried out on the present display device, the value (absolute value) of the voltage applied across the pixel electrodes often differs from one subframe to the next.

Therefore, if the polarity of the electrode-to-electrode voltage is reversed at the subframe cycle, the applied electrode-to-electrode voltage is biased due to the voltage change between the preceding subframe and the succeeding subframe. Thus, driving the liquid crystal panel 21 for an extended period of time, electric charge accumulates between electrodes, possibly causing the etching or flickering mentioned above.

Accordingly, in the present display device, the polarity of the electrode-to-electrode voltage is preferably reversed at a frame cycle (cycle of one frame duration). There are two approaches to the reversing of the polarity of the electrode-to-electrode voltage at a frame cycle. One of them is to apply voltage of the same polarity throughout a frame. The other approach is to reverse the polarity of the electrode-to-electrode voltage between the two subframes in each frame and maintain the polarity between each succeeding subframe and the preceding subframe of the immediately following frame.

FIG. 9(a) depicts a relationship between the voltage polarity (polarity of the electrode-to-electrode voltage) and the frame cycle for the former approach. FIG. 9(b) depicts a relationship between the voltage polarity and the frame cycle for the latter approach. Alternating the electrode-to-electrode voltage at the frame cycle in this manner prevents etching and flickering even when the electrode-to-electrode voltage differs greatly from one subframe to the next.

As described earlier, the present display device drives the liquid crystal panel 21 according to a subframe display scheme. That is how the device mitigates excess brightness. However, this advantage of subframe display can be somewhat lost if the liquid crystal has a slow response rate (rate at which the voltage across the liquid crystal (electrode-to-electrode voltage) becomes equal to the applied voltage).

In other words, for ordinary hold display on a TFT liquid crystal panel, one liquid crystal state corresponds to a luminance grayscale level. Therefore, the response characteristics of the liquid crystal does not depend on the luminance grayscale level represented by the display signal.

On the other hand, in subframe display as carried out on the present display device, to produce a display from a display signal representing a halftone grayscale level, in which the preceding subframe is designated for a minimum luminance (white) and the succeeding subframe is designated for a maximum luminance, the voltage applied across the liquid crystal over one frame alters as shown in FIG. 10(a). The electrode-to-electrode voltage changes as indicated by solid line X in FIG. 10(b) in accordance with the response rate (response characteristics) of the liquid crystal.

If that halftone display is produced when the liquid crystal has a slow response rate, the electrode-to-electrode voltage (solid line X) changes as shown in FIG. 10(c). Therefore, in this case, the display luminance in the preceding subframe is not a minimum and the display luminance in the succeeding subframe is not a maximum.

Hence, the relationship between the expected luminance and the actual luminance can be represented as shown in FIG. 11. The graph indicates that the subframe display fails at large viewing angles to produce a display with such luminance (minimum luminance and maximum luminance) that the difference (discrepancy) between the expected luminance and the actual luminance is small. The excess brightness phenomenon is thus less mitigated.

Therefore, to perform good subframe display as carried out by the present display device, the response rate of the liquid crystal in the liquid crystal panel 21 is preferably designed to meet conditions (c) and (d):
(c) If a voltage signal for a maximum luminance (white; equivalent to a maximum brightness), generated by the source driver 23 from a display signal, is applied to liquid crystal outputting a minimum luminance (black; equivalent to a minimum brightness), the voltage across the liquid crystal (electrode-to-electrode voltage) reaches 90% or more of the voltage represented by the voltage signal in the shorter one of two subframe periods (the actual brightness as viewed from the front reaches 90% of the maximum brightness); and
(d) If a voltage signal for a minimum luminance (black) is applied to liquid crystal outputting a maximum luminance (white), the voltage across the liquid crystal (electrode-to-electrode voltage) reaches 5% or less of the voltage represented by the voltage signal in the shorter one of two subframe periods (the actual brightness as viewed from the front reaches 5% of the minimum brightness).

The control section 15 is preferably designed to monitor the response rate of the liquid crystal. The control section 15 may be set up to discontinue the subframe display to drive the liquid crystal panel 21 by ordinary hold display if changes in ambient temperature or other factors slow down the response rate of the liquid crystal so much that the control section 15 has determined that it is no longer capable of meeting conditions (c), (d).

The setup enables switching of the display scheme of the liquid crystal panel 21 to ordinary hold display when the subframe display has intensified, rather than mitigated, an excess brightness phenomenon.

In the present embodiment, the present display device functions as a liquid crystal monitor. The present display device, however, may function as a liquid crystal television receiver (liquid crystal television). The liquid crystal television is realized by adding a tuner section 17 to the present display device shown in FIG. 8 as shown in FIG. 46. The tuner section 17 receives television broadcast signals and transmits the television broadcast signals to the control section 15 via the frame memory 11.

In this structure, the control section 15 generates the display signals from the television broadcast signals. The liquid crystal television can be realized also by adding a tuner section 17 to the present display device shown in FIG. 1.

In the present embodiment, in low luminance cases, the preceding subframe is designated for black, and only the succeeding subframe is used to produce a grayscale display. The same display is achieved even when the settings for the two subframes are transposed (in low luminance cases, the succeeding subframe is designated for black, and only the preceding subframe to produce a grayscale display).

In the present embodiment, the luminance grayscale levels of the display signals (pre-stage display signal and post-stage display signal) (signal grayscale levels) are set using equation 1. However, the actual panel has luminance even in black display cases (grayscale level=0), and moreover, the response rate of the liquid crystal is finite. Therefore, these factors are preferably taken into account in the setting of signal grayscale levels. More specifically, it is preferable to actually produce an image on the liquid crystal panel 21, actually measure relationship between the signal grayscale levels and the display luminance, and determine an LUT (output table) that fits equation 1 from results of the actual measurement.

In the present embodiment, α in equation (6a) is set in the range of 2.2 to 3. The range, although not technically proven, can be considered suitable in relation to human vision.

If a source driver for ordinary hold display is used as the source driver 23 in the present display device, voltage signals are supplied to pixels (liquid crystal) in accordance with the incoming signal grayscale levels (luminance grayscale level represented by a display signal) so that the display luminance obtained by setting γ to 2.2 in equation 1 can be obtained.

That source driver 23 outputs voltage signals as they are used in ordinary hold display in accordance with the incoming signal grayscale levels in each subframe even when subframe display is carried out.

This voltage signal output method may fail to equate the total luminance in one frame in subframe display to a value in the case of ordinary hold display (may fail to reproduce from the signal grayscale levels).

Therefore, in subframe display, the source driver 23 is preferably designed to output voltage signals converted for divided luminance. In other words, the source driver 23 is preferably set up to fine tune the voltage applied to the liquid crystal (electrode-to-electrode voltage) in accordance with the signal grayscale levels. To this end, it is preferable to design the source driver 23 for subframe display to enable the fine tuning.

In the present embodiment, the liquid crystal panel 21 is a VA panel. This is however not the only possibility. The excess brightness phenomenon can be mitigated by subframe display on the present display device even by using a liquid crystal panel of mode other than VA mode.

In other words, the subframe display implemented by the present display device is capable of mitigating the excess brightness phenomenon on liquid crystal panels with which there occurs a discrepancy between the expected luminance (expected brightness) and the actual luminance (actual brightness) at large viewing angles (liquid crystal panels of a mode in which grayscale gamma characteristics may change in relation to viewing angle change).

The subframe display implemented by the present display device is particularly effective with liquid crystal panels having such characteristics that the display luminance intensifies with increasing viewing angle. The liquid crystal panel 21 in the present display device may be NB (Normally Black; normally black) or NW (Normally White; normally white). Furthermore, in the present display device, the liquid crystal panel 21 may be replaced with another display panel (for example, an organic EL panel or a plasma display device panel).

The frame is preferably divided into 1:3 to 1:7 in the present embodiment. This is however not the only possibility. The present display device may be designed to divide the frame into 1:n or n:1 (n is a natural number greater than or equal to 1).

The present embodiment uses equation (10) to make signal grayscale level settings for the display signals (pre-stage display signal and post-stage display signal). The settings are made assuming that the response rate of the liquid crystal is 0 ms and that T0 (minimum luminance)=0. Therefore, in actual use, more elaborate settings are preferred.

Specifically, the maximum luminance (threshold luminance) that can be reached in one of the two subframes (succeeding subframe) equals Tmax/(n+1) when the liquid crystal response is 0 ms and T0=0. The threshold luminance grayscale level Lt is the frame grayscale level of that luminance.

Lt=((Tmax/(n+1)−T0)/(Tmax−T0))̂(1/γ)

(γ=2.2, T0=0)

If the response rate of the liquid crystal is not 0, for example, black→white is a Y % response in a subframe, white→black is a Z % response in a subframe, and T0=T0, the threshold luminance (Lt luminance) Tt is given by

Tt=((Tmax−T0)×Y/100+(Tmax−T0)×Z/100)/2

### Therefore,

Lt=((Tt−T0)/(Tmax−T0))̂(1/γ)

(γ=2.2)

Actually, Lt can in some cases be a little more complex with the threshold luminance Tt being unable to be given by a simple equation, making it difficult to give Lt in terms of Lmax. To obtain Lt in such cases, it is preferred to use results of measurement of the luminance of the liquid crystal panel. In other words, the luminance of the liquid crystal panel in a case where one of the two subframes outputs a maximum luminance, and the other subframe outputs a minimum luminance is measured, and the luminance is denoted by Tt. A spilled grayscale level Lt is determined from the following equation.

Lt=((Tt−T0)/(Tmax−T0))̂(1/γ)

(γ=2.2)

In this manner, it can be said that Lt obtained by using equation (10) has an ideal value and is in some cases preferably used as a rough reference.

Now, the fact that in the present display device, the polarity of the electrode-to-electrode voltage is preferably reversed at the frame cycle will be described in more detail. FIG. 12(a) is a graph representing the luminance in the preceding subframe and the succeeding subframe for a display luminance three quarters of Lmax and a display luminance a quarter of Lmax. As shown in the figure, when subframe display is carried out as on the present display device, the value of the voltage applied to the liquid crystal (value of the voltage applied across the pixel electrodes; absolute value) differs from one subframe to the next.

Therefore, if the polarity of the voltage applied to the liquid crystal (liquid crystal driving voltage) is reversed at the subframe cycle, as shown in FIG. 12(b), there occurs an irregular applied liquid crystal driving voltage (the total applied voltage does not equal 0 V) due to difference in voltage value between the preceding subframe and the succeeding subframe. Therefore, the DC component of the liquid crystal driving voltage cannot be eliminated. Thus, if the liquid crystal panel 21 is driven for an extended period of time, electric charge accumulates between electrodes, thereby possibly causing etching, burn-in, or flickering.

Accordingly, in the present display device, the polarity of the liquid crystal driving voltage is preferably reversed at the frame cycle. There are two approaches to the reversing of the polarity of the liquid crystal driving voltage at the frame cycle. One of them is to apply voltage of the same polarity throughout a frame. The other approach is to reverse the polarity of the liquid crystal driving voltage between the two subframes in each frame and maintain the polarity between each succeeding subframe and the preceding subframe of the immediately following frame.

FIG. 13(a) is a graph representing a relationship between the voltage polarity (liquid crystal driving voltage polarity), the frame cycle, and the liquid crystal driving voltage for the former approach. In contrast, FIG. 13(b) is a graph representing the same relationship for the latter approach.

As depicted in these graphs, if the liquid crystal driving voltage is reversed at one frame cycle, the total voltage of the preceding subframes of two adjacent frames and the total voltage of the succeeding subframes of the two adjacent frames can be rendered 0 V. Therefore, the total voltage over the two frames can be rendered 0 V, making it possible to eliminate the DC component of the applied voltage. Alternating the liquid crystal driving voltage at the frame cycle in this manner prevents etching, burn-in, and flickering even when the liquid crystal driving voltage differs greatly from one subframe to the next.

FIGS. 14(a) to 14(d) are illustrations showing four pixels in the liquid crystal panel 21 and the polarities of liquid crystal driving voltages for pixels. As mentioned earlier, the polarity of the voltage applied to each pixel is preferably reversed at the frame cycle. In a case like this, the polarities of the liquid crystal driving voltages for the pixels are changed at a frame cycle as shown in the order of FIGS. 14(a) to 14(d).

The sum of the liquid crystal driving voltages applied to all the pixels in the liquid crystal panel 21 is preferably 0 V. This control can be realized by, for example, changing voltage polarity between adjoining pixels as shown in FIGS. 14(a) to 14(d).

In the present embodiment, the ratio of the preceding subframe period and the succeeding subframe period (frame division ratio) is preferably set in a range from 3:1 to 7:1. This is however not the only possibility. The frame division ratio may be set in a range from 1:1 or 2:1.

For example, if the frame division ratio is set to 1:1, as shown in FIG. 3, the actual luminance can be brought closer to the expected luminance than in ordinary hold display. In addition, as shown in FIG. 6, the same is true with brightness; the actual brightness can be brought closer to the expected brightness than in ordinary hold display. Therefore, in a case like this, it is clear that viewing angle characteristics can again improve over ordinary hold display.

The liquid crystal panel 21 needs a time in accordance with the response rate of the liquid crystal to render the liquid crystal driving voltage (voltage applied to the liquid crystal; electrode-to-electrode voltage) have a value in accordance with the display signal. Therefore, if one of the subframe periods is too short, the voltage across the liquid crystal can possibly not raised to a value that is in accordance with the display signal within this period.

Setting the ratio between the preceding subframe and the succeeding subframe period to 1:1 or 2:1 prevents one of the two subframe periods from becoming too short. Therefore, suitable display can be carried out even when using a slow-response liquid crystal.

The frame division ratio (ratio of the preceding subframe and the succeeding subframe) may be set to n:1 (n is a natural number greater than or equal to 7). Alternatively, the frame division ratio may be set to n:1 (n is a real number greater than or equal to 1, preferably a real number greater than 1). Setting the frame division ratio to, for example, 1.5:1 improves the viewing angle characteristics over the 1:1 setting and makes it easier to use the slow-response liquid crystal material than the 2:1 setting.

Even in cases where the frame division ratio is set to n:1 (n is a real number greater than or equal to 1), to display an image with low luminance (low brightness), no brighter than 1/(n+1) times the maximum luminance (=Tmax/(n+1)), preferably, only the succeeding subframe is used to produce the display, with the preceding subframe being designated for black display. In addition, to display an image with high luminance (high brightness), Tmax/(n+1) or brighter, preferably, the luminance in only the preceding subframe is adjusted to produce a display, with the succeeding subframe being designated for white display. Accordingly, one subframe is always in such a state that there is no difference between the actual luminance and the expected luminance. Therefore, the present display device has good viewing angle characteristics.

If the frame division ratio is n:1, substantially the same effects are expected no matter which one of the preceding and succeeding frames is set to n. In other words, n:1 and 1:n are identical with respect to viewing angle improving effects. In addition, n, when it is a real number greater than or equal to 1, is effective in the control of the luminance grayscale levels using equations (10) to (12) shown above.

In the present embodiment, the subframe display implemented by the present display device is a display produced by dividing the frame into two subframes. This is however not the only possibility. The present display device may be designed to carry out subframe display in which the frame is divided into three or more subframes.

In the subframe display in which a frame is divided into m pieces, in a very low luminance case, the m-1 subframes are designated for black display, whilst the luminance (luminance grayscale level) of only one subframe is adjusted to produce a display. This subframe is designated for white display when the luminance becomes so high that this subframe alone cannot deliver the required luminance. The m-2 subframes are then designated for black display, whilst the luminance in the remaining one subframe is adjusted to produce a display.

In other words, even when the frame is divided into m pieces, preferably, there is always one and only one subframe of which the luminance is adjusted (changed) similarly to the case where the frame is divided into two pieces, whilst the other subframes are designated for either white display or black display. Accordingly, the m-1 subframes can be designated for a state in which there is no discrepancy between the actual luminance and the expected luminance. Therefore, the present display device has good viewing angle characteristics.

FIG. 15 is a graph representing results of displays produced on the present display device by dividing the frame equally into three subframes (broken line and solid line) as well as results of ordinary hold display (dash-dot line and solid line; similar to the results shown in FIG. 2. As can be seen from the graph, increasing the number of subframes to three moves the actual luminance closer to the expected luminance. Therefore, the present display device has further improved viewing angle characteristics.

Even when the frame is divided into m pieces, the aforementioned polarity reversion driving is preferably carried out. FIG. 16 is a graph representing transitioning of a liquid crystal driving voltage when the frame is divided into three subframes and the voltage polarity is reversed for each frame. As shown in the figure, in a case like this, the total liquid crystal driving voltage over the two frames can again be rendered 0 V.

FIG. 17 is a graph representing transitioning of a liquid crystal driving voltage when the frame is similarly divided into three subframes and the voltage polarity is reversed for each subframe. When the frame is divided into an odd number of pieces in this manner, even if the voltage polarity is reversed for each subframe, the total liquid crystal driving voltage over the two frames can be rendered 0 V. Therefore, when the frame is divided into m pieces (m is an integer greater than or equal to 2), liquid crystal driving voltage of different polarity is preferably applied in the M-th (M; 1 to m) subframes of adjoining frames under the control of the control section 15. Accordingly, the total liquid crystal driving voltage over the two frames can be rendered 0 V.

When the frame is divided into m pieces (m is an integer greater than or equal to 2), the polarity of the liquid crystal driving voltage is preferably reversed so that the total liquid crystal driving voltage over two (or more) frames becomes 0 V.

In the foregoing, when the frame is divided into m pieces, preferably, there is always one and only one subframe of which the luminance is adjusted, whilst the other subframes are designated for either white display (maximum luminance) or black display (minimum luminance).

This is however not the only possibility. There may be two or more subframes in which the luminance is adjusted. In a case like this, viewing angle characteristics are again improved by designating at least one subframe for white display (maximum luminance) or black display (minimum luminance).

The luminance in the subframes in which luminance is not adjusted may be set to, instead of a maximum luminance, a maximum or a value greater than a second predetermined value. That luminance may be set to, instead of a minimum luminance, a minimum or a value less than a first predetermined value. In a case like this, the discrepancy between the actual brightness and the expected brightness (brightness discrepancy) in the subframes in which luminance is not adjusted can again be reduced sufficiently. Therefore, the present display device has improved viewing angle characteristics.

FIG. 18 is a graph representing a relationship (viewing angle grayscale characteristics (actual measurements)) in the subframes in which luminance is not adjusted between a signal grayscale level output (%; luminance grayscale level represented by a display signal) on the display section 14 and the actual luminance grayscale level (%) in accordance with that signal grayscale level.

The “actual luminance grayscale level” refers to a result of conversion into a luminance grayscale level using equation 1 of a luminance output (actual luminance) on the liquid crystal panel 21 in the display section 14 in accordance with a signal grayscale level.

As can be seen from the graph, the aforementioned two grayscale levels are equal when the liquid crystal panel 21 is viewed from the front (that is, viewing angle=0°). In contrast, when the viewing angle is 60°, the actual luminance grayscale level appears brighter than signal grayscale level at halftone due to excess brightness. The excess brightness is a maximum when the luminance grayscale level is 20% to 30%, irrespective of viewing angle.

It is known that so long as the excess brightness does not exceed 10% of the maximum value indicated by the broken line in the graph, the present display device is capable of sustaining sufficiently display quality (keeping the aforementioned brightness discrepancy sufficiently small). The excess brightness stays within 10% of the maximum value when the signal grayscale level is in the ranges of 80 to 100% and 0 to 0.02% of its maximum value. These ranges are invariable with respect to the viewing angle.

Therefore, the second predetermined value is preferably set to 80% of the maximum luminance. The first predetermined value is preferably set to 0.02% of the maximum luminance.

In addition, there is no need to provide subframes in which luminance is not adjusted. In other words, when a display is to be produced using m subframes, there is no need to create different display states for the subframes. This configuration is still capable of the polarity reversion drive explained above whereby the polarity of the liquid crystal driving voltage is reversed at the frame cycle. When a display is to be produced using m subframes, creating a slight difference between the display states of the subframes can improve the viewing angle characteristics of the liquid crystal panel 21.

In the present embodiment, subframe display is used to improve the viewing angle characteristics of liquid crystal (mitigate excess brightness). This is however not the only possibility. The same subframe display is capable of also improving the display quality of moving images.

More specifically, if one follows the motion of an object being displayed by ordinary hold display with his/her eyes, he/she would perceive at the same time the color and brightness of the immediately preceding frame. That results in the viewer perceiving blurred object edges. In contrast, when producing a moving image by subframe display (especially, at low luminance), the luminance in one of the subframes in each frame is low. The low luminance subframe restrains visual mixing of the currently perceiving frame image and the immediately preceding frame image (color, brightness). The edge blurring is thereby prevented, improving the display quality of moving images.

The present display device may be designed to adjust light by PWM light adjustment. Liquid crystal display elements, like the liquid crystal panel 21, produce grayscale displays by controlling the amount of transmitted light. To do so, some light source (fluorescent tube, LED, etc.) is needed. Current, large liquid crystal display elements typically use a fluorescent tube for its high efficiency as a light source.

There are two popular light adjustment schemes for a light source: current-based light adjustment, or voltage light adjustment, and PWM light adjustment.

Current-based light adjustment varies the amplitude of current (lamp current) supplied to a light source to control the output light intensity (brightness) of the light source. See FIG. 19. If a fluorescent tube is used as the light source, the fluorescent tube does not light on with too small lamp current amplitudes. Thus, current-based light adjustment has a shortcoming that it cannot provide a wide light adjustment range (range of available brightness). Therefore, PWM light adjustment is a preferred choice in devices which require a wide light adjustment range such as liquid crystal televisions.

PWM light adjustment turns on/off the light source (fluorescent tube) at 90 Hz or a higher frequency at which a human does not perceive flickers so that the user can perceive the amount of light output averaged over time as brightness. See FIG. 20. Turn on/off control is typically carried out using a light adjustment signal (PWM light adjustment control signal) that is supplied externally.

FIG. 21 is a graph representing examples of a light adjustment signal waveform, a lamp current waveform, and an emission waveform (waveform of light output of a fluorescent tube) when the fluorescent tube is used as the light source. As shown in the figure, in this case, the lamp current waveform has a constant amplitude and goes OFF at a predetermined cycle. Actually, the frequency of the lamp current waveform is a few tens of thousand hertz, whereas the frequency of the light adjustment signal is a few hundred hertz. Therefore, the lamp current waveform is more packed than is shown in the figure.

FIG. 22 is a block diagram illustrating the internal structure of the present display device which performs PWM light adjustment. The structure differs from the one shown in FIG. 1 in that there are additionally provided a PWM light adjustment control circuit 31 and a light source driver circuit 32. In the shown example, the light source for the liquid crystal panel 21 is a plurality of fluorescent tubes 33 which are direct backlights (placed on the back of the liquid crystal panel 21).

In this structure, the control section 15 generates a light adjustment ratio signal indicative of the expected amount of light output of the fluorescent tubes 33, for output to the PWM light adjustment control circuit 31. The PWM light adjustment control circuit 31 then generates a signal indicative of the cycle of the turning on/off of the lamp current in accordance with the light adjustment ratio signal for transfer to the light source driver circuit 32. The light source driver circuit 32 generates the lamp current (pulse current) in accordance with the incoming signal, for output to all the fluorescent tubes 33.

PWM light adjustment may be combined with the subframe display schemes explained above. Simply combining PWM light adjustment and subframe display however possibly causes interference, such as flickers and horizontal stripes.

FIG. 23 is a graph representing an example of relationship between a light source emission waveform, a waveform for an electrode-to-electrode voltage of a liquid crystal (liquid crystal response waveform), and a waveform light transmitted by liquid crystal (transmission waveform) when PWM light adjustment is used in combination with ordinary hold display.

FIG. 24 is a graph representing the same kinds of waveforms when PWM light adjustment is used in combination with subframe display (for low luminance). In the examples shown in these figures, the frame frequency is 60 Hz, the light adjustment frequency (frequency at which the light source is turned on/off) is 150 Hz, and the light adjustment ratio (ratio of periods in which the light source is turned on/off) is 50%. All waveforms are drawn as a rectangular wave for the sake of simplicity.

As shown in FIG. 23, the frequency of the transmission waveform is near the light adjustment frequency (150 Hz) in ordinary hold display with PWM light adjustment. Under these conditions, the viewer starts to perceive flickering when the frequency of the transmission waveform is less than or equal to the flicker threshold (90 Hz) and clearly sees flickering when the frequency is below 60 Hz. Therefore, the user does not see flickering in ordinary hold display.

In contrast, as shown in FIG. 24, in subframe display with PWM light adjustment, the light adjustment frequency interferes with the subframe frequency. The transmission waveform frequency falls far below the light adjustment frequency (30 Hz in FIG. 24). That forces the user to see intense flickers.

Such flickers intensify as the light adjustment frequency approaches n.5 times the frame frequency (n is an integer). If the light adjustment frequency is n times the frame frequency, the transmission waveform frequency equals the frame frequency. Therefore, the flickers can be reduced so they are less recognizable. However, as the light adjustment frequency approaches n times the frame frequency, The interference (horizontal stripes) occurs on the screen.

FIG. 25 is a graph representing an example of relationship between a light source emission waveform, liquid crystal response waveforms, and transmission waveforms when PWM light adjustment is used in combination with subframe display. In the example in the graph, the light adjustment frequency (180 Hz) is 3 times the frame frequency (60 Hz). The figure, unlike FIG. 24, shows a liquid crystal response waveform and a transmission waveform for each of two lines A and B located at different places. As shown in the figure, the transmission waveform frequency is near the frame frequency at 60 Hz for both lines A and B.

The light source usually projects light simultaneously to each part of the screen. In contrast, the liquid crystal panel shines a line at a time. Therefore, the individual lines of the screen turn on/off at different times depending on where they are located. Therefore, the liquid crystal response waveform goes ON/OFF at different timings on lines A and B that are located at different places (slides with respect to time) as shown in FIG. 25.

Therefore, the ratio of the ON duration of the transmission waveform (duration of high luminance) differs from one line position to the next. Therefore, average luminance differs from one line to the other, which is recognized as horizontal stripes.

If the light adjustment frequency is exactly n times the frame frequency, the horizontal stripes sit still on the screen. As the light adjustment frequency deviates from n times, the horizontal stripes start to float up and down on the screen. As the light adjustment frequency further deviates from n times and approaches n.5 times, the horizontal stripes disappear.

In other words, if the light adjustment frequency is n.5 times the frame frequency, the light source emission waveform changes its phase by 180° between adjoining frames as shown in FIG. 24. Therefore, the transmission waveform from each line also changes its phase by 180° between adjoining frames. Thus, the amount of transmitted light from each line is invariable if summed over two adjoining frames (time compensated). No horizontal stripes occur.

Accordingly, the present display device implements the following control when PWM light adjustment and subframe display are used together. The control section 15 controls the circuit 31, 32 to set the light adjustment frequency to n.5 times the frame frequency, not lower than 450 Hz.

FIG. 26 is a graph representing an example of relationship between a light source emission waveform (fluorescent tube 33), liquid crystal response waveforms, and transmission waveforms in the current case. In the example in the graph, the light adjustment frequency (450 Hz) is 7.5 times the frame frequency (60 Hz). The figure, like FIG. 25, shows a liquid crystal response waveform and a transmission waveform for each of two lines A and B located at different places.

The light adjustment frequency is n.5 times the frame frequency in this case. Thus, the horizontal stripes mentioned above do not occur. Although the transmission waveform frequency is half the frame frequency at 30 Hz for both lines A and B, flickers are less recognizable because the light adjustment frequency is raised sufficiently.

In other words, the amounts of transmitted light for lines A and B shown in FIG. 26 are “transposed” for each frame (the amount of light for line A in frame 1 (or frame 2) is equal to the amount of light for line B in frame 2 (or frame 1)). If pairs of lines which are related this way are provided densely on the screen, the flickers are space compensated by the user viewing light from the pairs of lines simultaneously.

The on-screen distance separating the pair of lines related this way decreases with increasing light adjustment frequency. Therefore, the flickers become less recognizable by raising the light adjustment frequency sufficiently even if its value is set to n.5 times the frame frequency. Our experiments demonstrate that flickers are less recognizable if the light adjustment frequency is 450 Hz or higher when the luminance is set to 50% (at which value black display is on the verge of changing) in the preceding subframe (black insertion ratio=50%). Flickers are most recognizable when the black insertion ratio is 50%.

Therefore, the present display device is adapted to set the light adjustment frequency to n.5 times the frame frequency, not lower than 450 Hz, to prevent both the horizontal stripes and the flickers from occurring.

The interference can be mitigated without raising the light adjustment frequency as above. This is realized by, for example, setting the light adjustment frequency to n.5 times the frame frequency and inserting luminance correction pulses in the emission waveform.

FIG. 27 is a graph representing an example of relationship between a light source emission waveform (fluorescent tube 33), liquid crystal response waveforms, and transmission waveforms in the current case. The figure, like FIG. 26, shows a liquid crystal response waveform and a transmission waveform for each of two lines A and B located at different places. In the example in the graph, the control section 15 controls the fluorescent tubes 33 to output base light pulses with a relatively long pulse width at the light adjustment frequency (330 Hz; 5.5 times the frame frequency (60 Hz)). The light adjustment frequency is n.5 times the frame frequency in this case. Thus, the horizontal stripes mentioned above do not occur.

As to the flickering, the frequency of the transmission waveform of the base light pulse is 30 Hz, or half the frame frequency, for both lines A and B. However, the structure is adapted to input luminance correction pulses with a relatively short pulse width at the same frequency as the base light pulses (330 Hz), but in opposite phase.

The transmission waveforms for lines A and B show that the transmission amount of the base light pulses and the luminance correction pulses fluctuates from frame to frame and that the ratio inverts from frame to frame. For example, the ratio of the base light pulses (HIGH) in frame 1 and those in frame 2 is 2.5:3 (see pulses 3 to 5 and 8 to 10). In contrast, the ratio of the luminance correction pulses in frame 1 and those in frame 2 is 3:2.5 (inverse).

Hence, the transmission waveform, although its frequency (30 Hz) is low, possesses a reduced luminance difference in one cycle (two frames) (luminance difference between frames) owing to the use of the luminance correction pulses. Therefore, the flickers become less recognizable.

The structure reduces the PWM light adjustment frequency to below 450 Hz and thereby prevents light source driving efficiency from decreasing. The structure inserts the 330-Hz luminance correction pulses, which may raise concerns about poor efficiency. However, the luminance correction pulses has a pulse width which is much shorter than the frame period. Therefore, the insertion of the luminance correction pulses affects the light source driving efficiency in a sufficiently limited manner.

In the description so far, the light adjustment frequency is n.5 times the frame frequency. This is however not the only possibility. The light adjustment frequency may be set to n times the frame frequency. In a case like this, it would sufficiently prevent the horizontal stripes from occurring if the light source emission waveform is phase inverted for each frame as shown in FIG. 28. When that is the case, the transmission waveform from each line changes its phase by 180° between adjoining frames. Therefore, the amount of transmitted light for each line is invariable if summed over the two frames (time compensated). No horizontal stripes occur.

However, simply inverting the phase of the light source emission waveform for each frame results in the cycle of the transmission waveform for lines A and B equaling 30 Hz as shown in FIG. 28. Flickers follow.

Accordingly, when the phase of the light source emission waveform is inverted for each frame as above, the control section 15 first controls the fluorescent tubes 33 to output base light pulses with a relatively long pulse width at the light adjustment frequency (300 Hz; 5 times the frame frequency (60 Hz)) as shown in FIG. 29. The control section 15 then controls the base light pulses to appear with opposite phase in each frame.

The control section 15 inserts luminance correction pulses with a relatively short pulse width in the light source emission waveform at the same frequency as the base light pulses (330 Hz), but in opposite phase. Furthermore, the control section 15 inserts, in place of the luminance correction pulses, luminance correction additive pulses or luminance correction subtractive pulses when the base light pulses change in phase (frame boundaries in FIG. 29).

The luminance correction additive pulse is inserted when the base light pulses continue to be off (low) and turns on the light source. In contrast, the luminance correction subtractive pulse is inserted when the base light pulses continue to be on (high) and turns off the light source.

In other words, the structure is designed to increase the amount of light by inserting a luminance correction additive pulse when the amount of light of the base light pulses is too small and to decrease the amount of light by inserting a luminance correction subtractive pulse when the amount of light of the base light pulses is too large.

Accordingly, the structure reduces luminance difference between frames for each line (brings average luminance over each frame to a constant value). That reduces flickering.

When using PWM light adjustment in combination with subframe display, the light source emission waveform may be controlled to contain a DC component, to mitigate the interference, such as flickers and horizontal stripes.

FIG. 30 is a block diagram illustrating the structure of the present display device for the implementation of such control. The structure differs from the one shown in FIG. 22 in that the light source driver circuit 32 is replaced by a first light source driver circuit 34 and a second light source driver circuit 35 and also that there is additional provided a phase control circuit 36 between the circuits 34, 35 and the PWM light adjustment control circuit 31.

In the structure, the fluorescent tubes 33 are divided into two groups: a first group of fluorescent tubes 33a and a second group of fluorescent tubes 33b (a fluorescent tube 33a and a fluorescent tube 33b are provided alternately). The first group of fluorescent tubes 33a, providing a light source, is connected to the first light source driver circuit 34. The second group of fluorescent tubes 33b, providing a light source, are connected to the second light source driver circuit 35.

In this structure, the control section 15 generates a light adjustment ratio signal indicative of the expected amount of light output of the fluorescent tubes 33a and 33b and supplies the signal to the PWM light adjustment control circuit 31. Then, the PWM light adjustment control circuit 31 and the phase control circuit 36 generate a signal indicative of the cycle of the turning on/off of the lamp current for the first group of fluorescent tubes 33a in accordance with the light adjustment ratio signal for transfer to the first light source driver circuit 34 and generate a signal indicative of the cycle of the turning on/off of the lamp current for the second fluorescent tubes 33b in accordance with the light adjustment ratio signal for transfer to the second light source driver circuit 35. The light source driver circuits 34, 35 generate the lamp current (pulse current) in accordance with the incoming signal for output to the fluorescent tubes 33a and 33b.

The structure in FIG. 30 described above allows for the two groups of fluorescent tubes 33a and 33b to shine independently. FIGS. 31(a) and 31(b) are graphs representing an example of an emission waveform for the first group of fluorescent tubes 33a (first waveform), an emission waveform for the second group of fluorescent tubes 33b (second waveform), and a combined waveform of the emission waveform for the two groups of fluorescent tubes 33a and 33b (combined waveform) in the structure shown in FIG. 30. FIG. 31(a) shows a case where the light adjustment ratio (ratio of light emission to a maximum light emission by each fluorescent tube) is 75%, and FIG. 31(b) shows a case where the light adjustment ratio is 50%.

In the example in these figures, the control section 15 controls the first and second waveforms to be out of phase by 180°. Therefore, as shown in FIG. 31(a), 75% of emission is a DC component when the light adjustment ratio is 75%. In addition, as shown in FIG. 31(b), all emission (100%) is a DC component (which enables DC driving) when the light adjustment ratio is 50%.

The control reduces variations over time in the emission by the light source in one cycle (two frames) and also lowers difference in emission from line to line. That makes the interference, such as flickers and horizontal stripes, less recognizable without a need to increase the frequency of the light adjustment signal.

The control above in which the light source emission waveform is rendered to contain a DC component may be combined with either the control mentioned earlier in which the light adjustment frequency is set to n.5 times the frame frequency, not lower than 450 Hz, or the control mentioned earlier in which the luminance correction pulses are used.

We have confirmed in experiments that the control in which the light source emission waveform is rendered to contain a DC component makes the interference, such as flickers and horizontal stripes, sufficiently less recognizable even if the light adjustment frequency is set to n.5 times the frame frequency, not lower than 270 Hz.

In the structure shown in FIG. 30, the fluorescent tubes 33 are divided into two groups so that the light source emission waveform can contain a DC component. This is however not the only possibility. The fluorescent tubes 33 may be divided into three groups so that each group can be controlled independently. FIG. 32 is a block diagram illustrating the structure of the present display device for the implementation of such control.

In the structure, the fluorescent tubes 33 are divided into three groups: a first group of fluorescent tubes 33a, a second group of fluorescent tubes 33b, and a third group of fluorescent tubes 33c. A fluorescent tube 33a, a fluorescent tube 33b, and a fluorescent tube 33c are provided in this order repeatedly (one fluorescent tube belonging to the same group appears every three tubes). Also provided between the phase control circuit 36 and the fluorescent tubes 33 in the structure is a third light source driver circuit 37. The third light source driver circuit 37 drives (applies lamp current to) the third group of fluorescent tubes 33c.

The structure allows for the three groups of fluorescent tubes 33a to 33c to shine independently. FIGS. 33(a) and 33(b) are graphs representing an example of waveforms for the fluorescent tubes 33a to 33c (first to third waveforms) and a combined waveform of these waveforms (combined waveform) in the structure shown in FIG. 30.

FIG. 33(a) shows a case where the light adjustment ratio is 50% and FIG. 31(b) shows a case where the light adjustment ratio is 25%. In the example in these figures, the first to third waveforms are out of phase by 120°. Therefore, even where the light adjustment ratio is held at 50% as shown in FIGS. 33(a) and 33(b), there is a greater DC component than with the fluorescent tubes 33 simultaneously lighting on/off without being divided into groups.

This control reduces variations over time in the emission by the light source in one cycle (two frames) and also lowers difference in emission from line to line Therefore, That makes the interference, such as flickers and horizontal stripes, less recognizable without a need to increase the frequency of the light adjustment signal.

The number of groups of the fluorescent tubes 33 (number of separately driven groups of the fluorescent tubes) may be set to a given number if a matching number of light source driver circuits are provided. Preferably, the first to p-th waveforms are controlled to be out of phase by 360°/p where p is the number of groups of the fluorescent tubes 33 (p is a natural number greater than 1) as shown in FIG. 34. However, an easy PWM light adjustment scheme may be sufficient whereby only two fluorescent tubes 33 are controlled to produce emission waveforms that are out of phase with respect to each other. The structure again results in discrepancy in the light source emission waveforms, thereby increasing the DC component in the combined light of all the light sources.

In the foregoing description, the light source for the liquid crystal panel 21 is a plurality of fluorescent tubes 33 which are direct backlights. This is however not the only possibility. The light source may be LEDs (light emitting diodes) placed along a side/sides, including the top and/or bottom, of the liquid crystal panel 21 (“side backlight”). The display element shown in FIG. 35 includes a light guide 41 on the back of the liquid crystal panel 21 and a first LED 42 and a second LED 43 on two opposite sides (top and bottom) of the light guide 41. In the structure, the light guide 41 is designed to spread the emission from the LEDs 42, 43 and output it to the liquid crystal panel 21 as planar light.

In the structure, as in the one in FIG. 30, the control section 15 controls the emission waveform for the first LED 42 (first waveform) and the emission waveform for the second LED 43 (second waveform) to be out of phase by 180°. That control enables mixing the emission waveform in opposite phase in the light guide 41, producing a DC component. Therefore, the structure again increases the DC component in the light projected onto the liquid crystal panel 21.

When the two LEDs 42, 43 are used as above, the LEDs 42, 43 may be provided along the same side of the light guide 41 as shown in FIG. 36. The structure, like the one in FIG. 35, illuminates the liquid crystal panel 21 with light containing a large DC component.

The two LEDs 42, 43 may be used as a frontlight and placed along a side/sides, including the top and/or bottom, of the liquid crystal panel 21 (“side frontlight”). In a case like this, the liquid crystal panel 21 is structured as a frontlight type as shown in FIGS. 37 and 38.

In the structure, the liquid crystal panel 21 is a reflective liquid crystal display element. In other words, the structure is designed so that the liquid crystal panel 21 receives the planar light on its front (the side facing the user) from the light guide 41. The planar light is reflected from an internal reflective plate to present an image to the user.

In the structure shown in FIG. 34, the numerous fluorescent tubes 33 are divided into p groups, and the first to p-th waveforms are controlled to be out of phase by 360°/p. This is however not the only possibility. Each fluorescent tube 33 may be driven individually. In a case like this, preferably, the emission waveforms for the fluorescent tubes 33 are out of phase by 360°/r where r is the number of the fluorescent tubes 33 used.

In the structure where the numerous fluorescent tubes 33 are driven independently, the emission timings for the fluorescent tubes 33 and the gate line ON timings for the liquid crystal panel 21 is preferably synchronized.

FIG. 39 is a block diagram illustrating the structure of the present display device for the implementation of such synchronization. The structure is designed so that first to r-th light source driver circuits 32a to 32r can drive the r fluorescent tubes 33 disposed directly below the liquid crystal panel 21.

In the structure, each fluorescent tube 33 illuminates gate lines that are located close to the tube 33. For example, if there are provided 18 fluorescent tubes 33 and 768 gate lines, each fluorescent tube 33 is assigned to 42 to 43 gate lines.

The control section 15 controls to start driving a fluorescent tube 33 when a synchronization signal, fed to the phase control circuit 36, turns on a group of gate lines corresponding to that particular fluorescent tube 33 (when the scanning of the group of gate lines is started). To describe it in more detail, not all the groups of gate lines turn on simultaneously. The drive start timings for the fluorescent tubes 33 are set to the average of ON timings for the groups of gate lines.

FIG. 40 is a graph representing an example of relationship between light source emission waveforms, liquid crystal response waveforms, and transmission waveforms for the implementation of such control. In the example in the graph, the light adjustment frequency (180 Hz) is three times the frame frequency (60 Hz). The figure shows light source emission waveforms, liquid crystal response waveforms, and transmission waveforms for two groups of gate lines A, B. The liquid crystal response waveform represents a voltage that is written to the pixels in the liquid crystal panel 21 at a gate line ON timing and maintained until a next ON timing.

As shown in the figure, in the structure, the frequency of the light source emission waveform is three times the frame frequency. Therefore, the frequency of the transmission waveform is near the frame frequency at 60 Hz for both groups of lines A, B. That prevents flickers from occurring.

In the structure, the phases of the emission waveforms for the fluorescent tubes 33 correspond to those of the liquid crystal response waveforms for both groups of lines A, B (the time discrepancy between the light source emission waveform for the group of lines A and the light source emission waveform for the group of lines B matches the discrepancy in liquid crystal response waveform between the groups of lines A, B).

Therefore, the structure prevents the ratio of the ON duration of the transmission waveform (duration of high luminance) from differing from one line position to the next. Therefore, average luminance does not differ from one line to the other. That prevents horizontal stripes from occurring.

In the foregoing, the driving of a fluorescent tube 33 is started when a group of gate lines corresponding to that particular fluorescent tube 33 goes ON (when the scanning of the group of gate lines is started).

However, the phases of the emission waveforms for the fluorescent tubes 33 come to correspond to those of the liquid crystal response waveforms for all the groups of gate lines also by such control that any of the fluorescent tubes 33 (all the groups of gate lines) produces an identical waveform when a group of gate lines corresponding to that fluorescent tube 33 goes ON. This control again synchronizes the emission of the fluorescent tubes 33 with the ON timings for the groups of gate lines, thereby preventing horizontal stripes from occurring.

The present embodiment employs PWM light adjustment as the light adjustment scheme for the light source. This is however not the only possibility. PWM light adjustment may be used in combination with current-based light adjustment. FIG. 41 is a block diagram illustrating the structure of the present display device for such cases. The structure differs from the one shown in FIG. 22 in that there is additionally provided a current-based light adjustment control circuit 51.

In this structure, the control section 15 generates a light adjustment ratio signal indicative of the expected amount of light output of the fluorescent tubes 33, for output to the PWM light adjustment control circuit 31 and the current-based light adjustment control circuit 51. The light adjustment control circuits 31, 51 then generate a signal indicative of the cycle of the turning on/off of the lamp current (current-based light adjustment control signal, PWM light adjustment control signal) in accordance with the light adjustment ratio signal for transfer to the light source driver circuit 32. The light source driver circuit 32 generates the lamp current (pulse current) in accordance with the incoming signal, for output to all the fluorescent tubes 33.

FIG. 42 is a graph representing examples of a current-based light adjustment control signal, a PWM light adjustment control signal, a lamp current, and an emission waveform for the structure. As shown in the figure, the structure is adapted so that the control section 15 controls the light adjustment control circuits 31, 51 and output a constant current-based light adjustment control signal (signal for a constant emission power) together with the PWM light adjustment control signal.

Accordingly, the lamp current waveform for the fluorescent tube 33 is a sum of a constant amplitude in accordance with the current-based light adjustment control signal and an amplitude in accordance with the PWM light adjustment control signal. Therefore, the emission waveform for the fluorescent tube 33 contains, as shown in FIG. 42, a DC component in accordance with the constant current-based light adjustment control signal.

By using a combination of a PWM light adjustment scheme and a current-based light adjustment scheme in this manner, the DC component in the emission waveform is readily increased. The increased DC component reduces variations over time in the emission by the light source in one cycle (two frames) and also lowers difference in emission from line to line, which in turn makes the interference, such as flickers and horizontal stripes, less recognizable without a need to increase the frequency of the light adjustment signal.

The emission of the light source is preferably controlled according to external light if the liquid crystal panel 21 is a reflective liquid crystal display element and the present display device is a frontlight-type reflective liquid crystal display.

FIG. 43 is an illustration of the structure of the present display device for the implementation of such control. As shown in the figure, in the liquid crystal panel 21 in that structure, light from the LED 63, a light source, becomes planar as it travels through the light guide 41 and hits the front (the side facing the user) of the panel 21. The planar light reflects from the internal reflective plate, producing an image display for the user.

The structure includes a light source emission adjustment control circuit 62 to control the luminance of the LED 63. The light source emission adjustment control circuit 62 senses the luminance waveform of external light and adjusts the luminance of the LED 63 to increase the DC component in the light emitted by the liquid crystal panel 21.

In other words, supposing external light with a luminance waveform shown in FIG. 44(a), the light source emission adjustment control circuit 62 controls the luminance waveform (emission waveform) of the LED 63 to have the same frequency as the luminance waveform of the external light and opposite phase, as shown in FIG. 44(b). The control produces light with a large DC component, shown in FIG. 44(c), being projected onto the liquid crystal panel 21.

The structure reduces variations over time in the emission by the light source in one cycle (two frames) and also lowers difference in emission from line to line. That makes the interference, such as flickers and horizontal stripes, less recognizable without a need to increase the frequency of the light adjustment signal.

When the liquid crystal panel 21 is a backlight-type transflective liquid crystal display element shown in FIG. 45, the light source emission adjustment control circuit 62 is still useful to accomplish the same control. A transflective display device performs transmission display (transmission mode) by using light from the backlight when it is indoors or in a like relatively dark environment and performs reflection display (reflection mode) by using ambient light when it is outdoors or in a like relatively bright environment. Accordingly, the liquid crystal panel 21 produces a high contrast ratio display regardless of ambient brightness.

In the structure, the light source emission adjustment control circuit 62 again controls the luminance waveform of the LED 63 to be out of phase by 180° from the luminance waveform of the external light. The control produces light with a large DC component, in which two kinds of light of the same frequency and in opposite phase are mixed as shown in FIG. 44(c), being projected onto the liquid crystal panel 21.

In the present embodiment, the light source for the present display device is supposed to be a fluorescent tube, an LED, etc. This is however not the only possibility. Other examples of the light source for the present display device may include an EL (Electro luminescence) device and an FED (Field Emission Display). Alternatively, the light source may be provided by a combination of the fluorescent tube, the LED, the EL device, and the FED. FIGS. 34 to 38, among others, show an elongated light source(s). The light source may however be round or shaped like the letter U. The light source may assume any shape in the present invention.

When subframe display and PWM light adjustment are employed together, the display section 14 in the present display device is not limited to the liquid crystal display element, and may be any display element provided that it is a non-self-laminating display element (element which needs a light source).

In the present embodiment, the control section 15 both sends a display signal to the liquid crystal panel 21 and controls PWM light adjustment. This is however not the only possibility. A member (PWM light adjustment control section) which controls the PWM light adjustment may be provided separately from the control section 15. Therefore, the present display device could be described as follows. It displays an image by dividing each frame into m subframes (m is an integer greater than or equal to 2) and includes a display section and a control section. The display section has a display screen, provided by a liquid crystal display element, which displays an image with luminance in accordance with a display signal voltage. The control section generates first to m-th display signals for the first to m-th subframes for output to the display section so that the dividing of the frames does not change a sum luminance output of the display section in each frame. The display device further includes a PWM light adjustment control section which adjusts emission of a light source in the display section by PWM light adjustment.

If the present display device is used as a liquid crystal television, the tuner section 17 may select a channel for television broadcast signals and transfer the selected channel's television image signals to the control section 15 via the frame memory 11. In the structure, the control section 15 generates display signals from the television image signals. Alternatively, the tuner section 17 may select a channel for television broadcast signals and transfer the selected channel's television image signals to the control section 15 through various video processing circuitry (not shown).

The display device of the present invention could be described as follows. It displays an image by dividing each frame into two subframes (first and second) and includes a display section and a control section. The display section displays an image with luminance in accordance with a luminance grayscale level represented by an incoming display signal. The control section generates first and second display signals for the first and second subframes for output to the display section so that the dividing of the frames does not change a sum luminance output of the display section in each frame. For a low brightness image display, the control section adjusts a luminance grayscale level represented by the first display signal and sets a luminance grayscale level represented by the second display signal to a minimum or a value lower than a first predetermined value (for example, 0.02% of a maximum grayscale level). On the other hand, for a high brightness image display, the control section sets the luminance grayscale level represented by the first display signal to a maximum or a value higher than a second predetermined value (for example, 80% of a maximum grayscale level), adjusts the luminance grayscale level represented by the second display signal, sets the duration ratio of the first and second subframes to 1:n or n:1 (n is a real number greater than 1), and adjusts emission of a light source in the display section by PWM light adjustment.

The display device shown in FIG. 39 could be described as follows. It displays an image by dividing each frame into m subframes (m is an integer greater than or equal to 2) and includes a display section and a control section. The display section has a display screen, provided by a liquid crystal display element, which displays an image with luminance in accordance with a display signal voltage. The control section generates first to m-th display signals for the first to m-th subframes for output to the display section so that the dividing of the frames does not change a sum luminance output of the display section in each frame. The control section is adapted to adjust emission of light sources in the display section by PWM light adjustment. The display section has a group of direct light sources positioned side by side. Each light source is designed to illuminate a group of gate lines positioned close to that light source. The control section sets the frequencies of the light source emission waveforms to n times the frame frequency. The control section also carries out PWM light adjustment in such a manner that any one of the light sources exhibits the same emission waveform when the liquid crystal response waveform for one of the groups of gate lines assigned to that light sources are ON.

In the description so far, all processing in the present display device is done under the control of the control section 15. This is however not the only possibility. Computer programs for the implementation of the processing may be stored in a storage medium, and an information processing device capable of reading the programs may replace the control section 15.

In the structure, a computing device (CPU, MPU, etc.) in the information processing device reads the programs from the storage medium and executes the processing. In other words, the programs per se realize the processing.

The information processing device may be, apart from a general computer (workstation, personal computer, etc.), an extension board or an extension unit attached to a computer.

The computer program is software program code (executable program, intermediate code program, source program, etc.) which implements the processing. The program may be used alone or in combination with another program (e.g., OS). The program may be read from a storage medium, temporarily loaded into memory (e.g., RAM) in the device, and read again from the memory for execution.

The storage medium in which the program is stored may be readily separable from the information processing device or fixed (attached) to the device. Alternatively, the storage medium may be an external storage device connectable to the information processing device.

Examples of such a storage medium include magnetism tapes, such as video tapes and cassette tapes; magnetism disks, such as, floppy® disks and hard disks; optical discs (magneto-optical discs), such as CDs, MOs, MDs, and DVDs; memory cards, such as IC cards and optical cards; and semiconductor memories, such as mask ROMs, EPROMs, EEPROMs, and flash ROMs.

The storage medium may be connected to the information processing device over a network (Intranet, Internet, etc.). In a case like this, the information processing device obtains the programs by downloading them over the network. In other words, the programs may be obtained over a transmission medium (which carries the program in a flowing manner) such as a network (either wired or wireless). A download program is preferably contained in the device (or transmission end device or receiving end device) in advance.

The liquid crystal response waveform is output when the gate line goes ON. The liquid crystal response waveform is written to liquid crystal pixels, and the voltages across the liquid crystal pixels are maintained until the gate line goes ON next time. Patent Document 6 describes a method of reducing interference stripes caused when light source PWM light adjustment is used in combination with a black addressing scheme whereby black is inserted in each frame in the liquid crystal display to realize pseudo impulse mode. In the document, the technology attempts to improve by several methods. According to one of them, each frame period is divided into a black color display period and an image display period. The black color display period takes up a certain ratio of each frame in driving liquid crystal. Another method drives a backlight under certain PWM light adjustment frequency conditions. Another is to shift the phase of a PWM light adjustment signal for a plurality of backlights.

A different technique of realizing pseudo impulse mode in a liquid crystal driving method is described in Patent Document 3 (time divisional grayscale addressing). According to the technique, each frame is divided into a plurality of subframe periods. Luminance is high in some subframes and low in others. Grayscale levels are achieved by time integral with respect to all the subframes. The scheme has an advantage of improved moving image display performance: it reduces edge blurring while restraining a drop in display luminance on the screen when compared to methods whereby black is always inserted. Nevertheless, if the technique is used in combination with a light source for PWM light adjustment as with black inserting schemes, interference phenomena occur.

Black addressing in pseudo impulse mode completely blocks the light source. Therefore, when the black insertion duration is changed, the overall absolute luminance may change, but grayscale levels remain unchanged. Time divisional grayscale addressing has a constraint that when the duration of a subframe is changed, luminance and grayscale levels also change. In addition, the emission of the light source is modulated according to the liquid crystal response waveform and transmitted even in low luminance subframe periods. Control timing adjusting techniques are not applicable by which, for example, the periods in which the light source is turned off is synchronized with the insertion periods.

For these reasons, a major objective of the present invention may be described as the mitigating, without affecting grayscale and screen display, of flickering and other interference phenomena which occur when a light source for PWM light adjustment is used in combination with a pseudo impulse driving method, by time divisional grayscale addressing which involves a display mechanism which divides each frame period into two or more subframe periods and displays grayscale levels by time integral with respect to the subframes.

The present invention could be described as the following first to twenty-third display devices. The first display device is arranged to include means for controlling a PWM light adjustment signal to mitigate interference phenomena which occur when a light source for PWM light adjustment is used in combination with a driving method which involves a display mechanism which divides each frame period into two or more subframe periods and displays grayscale levels by time integral with respect to the subframes.

The second display device is the first display device arranged to control the PWM light adjustment signal so that the light source emission waveform is time and space compensated, to mitigate interference phenomena.

The third display device is the first display device arranged to control the PWM light adjustment signal so that the light source emission waveform contains as large a DC component as possible, to mitigate interference phenomena.

The fourth display device is the first display device arranged to control the PWM light adjustment signal so that the light source emission waveform is time and space compensated and that the light source emission waveform contains as large a DC component as possible, to mitigate interference phenomena.

The fifth display device is the second display device arranged to drive a control signal for the PWM light adjustment at a frequency n.5 times the frame frequency.

The sixth display device is the fifth display device arranged to drive at a frequency for PWM light adjustment not lower than 450 Hz for a 50% black insertion ratio.

The seventh display device is the fifth display device arranged to include control means for producing compensating light adjustment pulses for constant luminance.

The eighth display device is the second display device arranged to drive a control signal for the PWM light adjustment at a frequency n times the frame frequency and invert its phase from frame to frame.

The ninth display device is the eighth display device arranged to include control means for producing light adjustment pulses which compensate to obtain constant luminance.

The tenth display device is the third display device arranged to include a first light source, a second light source, and means for controlling so that the PWM light adjustment phases differ by 180°.

The eleventh display device is the third display device arranged to include a first light source, a second light source, a third light source, and means for controlling so that the PWM light adjustment phases differ by 120°.

The twelfth display device is the third display device arranged to include first to n-th light sources and means for controlling so that the PWM light adjustment phases differ by 360°/n.

The thirteenth display device is the tenth to twelfth display devices arranged to include light sources which are direct backlights and positioned spatially alternately.

The fourteenth display device is the tenth to twelfth display devices arranged to include light sources which are side backlights and those of which located at both ends are in opposite phase.

The fifteenth display device is the tenth to twelfth display devices arranged to include light sources which are side backlights and those of which located at an end are in opposite phase.

The sixteenth display device is the tenth to twelfth display devices arranged to include light sources which are frontlights and those of which located at both ends are in opposite phase.

The seventeenth display device is the tenth to twelfth display devices arranged to include light sources which are frontlights and those of which located at an end are in opposite phase.

The eighteenth display device is a combination of any one of the fifth to eighth display devices and any one of the thirteenth to sixteenth display devices.

The nineteenth display device is, to mitigate interference phenomena arranged to scan control parallel light sources in synchronism with line scan driving of the liquid crystal panel.

The twentieth display device is arranged to operate with PWM light adjustment and current-based light adjustment and increases the DC component in the light source emission waveform in advance by the current-based light adjustment to mitigate interference phenomena.

The twenty-first display device is the second display device arranged to control the PWM light adjustment for a light source so that light from the light source is in opposite phase with the luminance component detected by a sensor section detecting external light.

The twenty-second display device is the twenty-first display device and a reflective liquid crystal, arranged to control the PWM light adjustment for a frontlight light source so that light from the light source is in opposite phase with the external light. Alternatively, the twenty-second display device is the twenty-first display device and a transflective liquid crystal, arranged to control the PWM light adjustment for a backlight light source so that light from the light source is in opposite phase with the external light.

The twenty-third display device is any one of the first to twenty-second display devices arranged so that the light source is any one of a fluorescence lamp, an LED, an EL device, an FED, and their combinations.

### INDUSTRIAL APPLICABILITY

The present invention is suitable for applications to devices with a display screen in which an excess brightness phenomenon may occur.

1. A display device displaying an image by dividing each frame into m subframes (m is an integer greater than or equal to 2), said display device comprising:
a display section including a display screen, provided by a liquid crystal display element, which displays an image with luminance in accordance with a display signal voltage; and
a control section generating first to m-th display signals for the first to m-th subframes for output to the display section so that the dividing of the frames does not change a sum luminance output of the display section in each frame,
wherein
the control section adjusts emission of a light source in the display section by PWM light adjustment.

2. The display device of claim 1, wherein the control section carries out PWM light adjustment so that the light source exhibits an emission waveform having a frequency n.5 times that of the frames (n is an integer), not lower than 450 Hz.

3. The display device of claim 1, wherein the control section carries out PWM light adjustment so that the light source exhibits an emission waveform having a frequency n.5 times that of the frames, the waveform being a combination of base light pulses and luminance correction pulses which are in opposite phase and of different pulse widths.

4. The display device of claim 1, wherein the control section:
controls the light source to exhibit an emission waveform having a frequency n times that of the frames, the waveform being a combination of base light pulses and luminance correction pulses which are of the same frequencies and in opposite phase, the base light pulses inverts in phase for each frame; and
carries out PWM light adjustment so as to insert, to an emission waveform of the light source, luminance correction additive pulses, replacing the luminance correction pulses, to turn on the light source where the base light pulses continue to be off and luminance correction subtractive pulses, replacing the luminance correction pulses, to turn off the light source where the base light pulses continue to be on.

5. The display device of claim 1, wherein:
the display section includes two or more light sources; and
the control section carries out PWM light adjustment so that at least two of the light sources exhibit emission waveforms with different phases.

6. The display device of claim 5, wherein the control section is designed to divide the light sources into p groups (p is a natural number greater than 1) and controls the light sources to exhibit emission waveforms which are out of phase by 360°/p for each group.

7. The display device of claim 5, wherein the light sources are direct backlights.

8. The display device of claim 5, wherein the light sources are side backlights.

9. The display device of claim 5, wherein the light sources are side frontlights.

10. The display device of claim 1, wherein:
the display section includes a group of direct light sources, positioned side by side, each of which is designed to illuminate a group of gate lines positioned close to that light source; and
the control section controls the light sources to exhibit emission waveforms having a frequency n times that of the frames and carries out PWM light adjustment so that any one of the light sources exhibits the same emission waveform when one of the groups of gate lines assigned to that light source goes ON.

11. The display device of claim 1, wherein the control section carries out PWM light adjustment while supplying a constant emission power to the light source.

12. The display device of claim 1, wherein:
the display section is a reflective display element with a frontlight-type light source;
said display device further comprises a luminance sensor detecting a luminance waveform of external light shining onto the display section; and
the control section carries out PWM light adjustment so that the light source exhibits an emission waveform which is of the same frequency as, and in opposite phase with respect to, the luminance waveform of the external light.

13. The display device of claim 1, wherein:
the display section is a transflective display element;
said display device further comprises a luminance sensor detecting a luminance waveform of external light shining onto the display section; and
the control section carries out PWM light adjustment so that the light source exhibits an emission waveform which is of the same frequency as, and in opposite phase with respect to, the luminance waveform of the external light.

14. The display device of claim 1, wherein the light source is any one of a fluorescent tube, an LED, an EL device, and an FED.

15. A liquid crystal monitor, comprising:
the display device of claim 1; and
a signal feeder section for feeding externally supplied image signals to the control section,
wherein
the control section in the display device is designed to generate the display signals from the image signals.

16. A liquid crystal television image receiver, comprising:
the display device of claim 1; and
a tuner section receiving television broadcast signals,
wherein
the control section in the display device is designed to generate the display signals from the television broadcast signals.

17. A method of displaying an image by dividing each frame into m subframes (m is an integer greater than or equal to 2), said display method comprising the steps of:
(a) generating first to m-th display signals for the first to m-th subframes for output to a display section provided by a liquid crystal display element so that the dividing of the frames does not change a sum luminance output of the display section in each frame; and
(b) adjusting emission of a light source in the display section by PWM light adjustment.
